(19) United States
(12) Patent Application Publication
(10) Pub. No.: US 2026/0112509 A1
(43) Pub. Date: Apr. 23, 2026

(54) APPARATUSES AND METHODS FOR NUCLEAR FUSION VIA TANDEM MIRROR

(71) Applicant: Realta Fusion Inc., Madison, WI (US)

(72) Inventor: Samuel FRANK, Madison, WI (US)

(21) Appl. No.: 19/354,457

(22) Filed: Oct. 9, 2025

Related U.S. Application Data
(60) Provisional application No. 63/709,350, filed on Oct. 18, 2024.
(60) Provisional application No. 63/709,900, filed on Oct. 21, 2024.

(51) Int. Cl. G21B 1/05; G21B 1/15; G21B 1/17

(52) U.S. Cl. CPC G21B 1/05; G21B 1/15

(57) ABSTRACT

A nuclear fusion reactor includes a first confinement element having axial ends, which define an inner region configured to have a first plasma population disposed therein and produces an axial magnetic field between the axial ends, the axial magnetic field configured to confine the first plasma population in the radial direction, and generate a magnetic mirror effect to confine the first plasma population in an axial direction at axial ends. Second and third confinement elements are disposed outside the first confinement element proximate to corresponding axial ends, and have a second and third plasma population disposed therein, respectively. The second and third plasma populations generate electrostatic barriers at the corresponding axial ends, to form a tandem mirror further confining the first plasma population in the inner region along the axial direction.

### CROSS-REFERENCE TO RELATED APPLICATIONS

The present application claims priority to and benefit of U.S. Provisional Application No. 63/709,350, filed Oct. 18, 2024, and entitled “Apparatuses and Methods for Nuclear Fusion via Tandem Mirror,” and U.S. Provisional Application No. 63/709,900, filed Oct. 21, 2024, and entitled “Apparatuses and Methods for Nuclear Fusion via Tandem Mirror,” the entire disclosures of which are incorporated herein by reference.

### GOVERNMENT LICENSE RIGHTS

This invention was made with government support under Contract No. DE-SC0024887 awarded by the U.S. Department of Energy. The government has certain rights in the invention.

### TECHNICAL FIELD

The embodiments described herein relate generally to systems, apparatuses, and methods for producing nuclear fusion reactions.

### BACKGROUND

Production of electricity is a major contributor to greenhouse emissions and global warming. Traditionally, electricity has been generated by burning carbon-based fossil fuels, such as oil, gas, or coal, but such conventional processes emit a large amount of carbon dioxide (CO₂) and other greenhouse gases into the atmosphere. The World Nuclear Association estimates that fossil fuel burning processes are responsible for about 34 billion gross tons (Gt) of CO₂ emissions per year, about 45% of which is from coal, about 35% from oil, and about 20% from gas. Despite global initiatives to reduce greenhouse gas emissions and stringent environmental regulations, fossil fuel burning processes remain the primary means of generating electricity in the United States, having accounted for greater than half of the US's annual energy production in recent years. As the global demand for electricity continues to rise, so too does the rate of climate change, along with the frequency of environmental disasters (e.g., hurricanes, flooding, droughts, etc.). Therefore, the urgency to reduce reliance on carbon-consuming processes for the generation of electricity on a global scale continues to increase.

Nuclear energy is an alternative method of producing energy, and unlike traditional fossil fuel based energy generation, it does not directly emit greenhouse gases into the environment. Nuclear fission, which relates to splitting of uranium atoms to produce energy, is currently utilized in nuclear power plants around the world to supply nearly 9% of the world's electricity needs. However, nuclear fission requires scarcely available raw materials and produces a significant amount of long-lived radioactive waste as a byproduct, which needs to be managed appropriately to avoid harm to humans and the environment. In contrast, nuclear fusion is generally a process by which two or more light atomic nuclei (e.g., deuterium and tritium) combine to form one heavier atomic nucleus (e.g., helium). The fusion process releases a tremendous amount of energy, which is proportional to the difference in mass between the reactants and the product. Unlike nuclear fission, the fuel sources for nuclear fusion are abundant, and the process generally does not produce greenhouse gases or long-lived radioactive waste.

### SUMMARY

Embodiments described herein relate generally to apparatuses and methods for producing nuclear fusion reactions, and, in particular, to a tandem mirror nuclear fusion reactor having a first confinement element having two axial ends, a second confinement element disposed proximate one end of the first confinement element, and a third confinement element disposed proximate the other end of the first confinement element. Each confinement element is configured to contain or hold a plasma population via electromagnetic and/or electrostatic confinement, and particularly, the plasma populations in the second confinement element and the third confinement element form a tandem mirror to at least partially confine the plasma population within the first confinement element to promote a fusion reaction therein.

In some embodiments, a nuclear fusion reactor includes: a first confinement element having axial ends, the first confinement element at least partially defining an inner region configured to have a first plasma population disposed therein, the first confinement element configured to produce an axial magnetic field between the axial ends and generate a magnetic mirror effect at each axial end, the axial magnetic field configured to at least partially confine the first plasma population in the inner region along a radial direction, and the magnetic mirror effect configured to at least partially confine the first plasma population in the inner region along an axial direction perpendicular to the radial direction; a second confinement element disposed outside the first confinement element proximate a first axial end of the first confinement element, the second confinement element configured to have a second plasma population disposed therein; and a third confinement element disposed outside the first confinement element proximate a second axial end of the first confinement element, the third confinement element configured to have a third plasma population disposed therein, the second plasma population and the third plasma population configured to generate electrostatic barriers at each corresponding axial end, the electrostatic barriers configured to form a tandem mirror that further confines the first plasma population in the inner region along the axial direction.

In some embodiments, a nuclear fusion reactor, includes: a confinement element having a first end and a second end opposite the first end, the confinement element at least partially defining an inner region configured to have a first plasma population disposed therein, the confinement element configured to produce an axial magnetic field between the first end and the second end, the axial magnetic field configured to confine the first plasma population within the inner region in a radial direction and generate a magnetic mirror effect at the first and second ends of the confinement element to at least partially confine the first plasma population in the inner region in an axial direction; a first end plug disposed proximate the first end of the confinement element; and a second end plug disposed proximate the second end of the confinement element; the first end plug including a second plasma population, the second plasma population configured to form a first electrostatic barrier between the first end plug and the inner region and proximate the first end of the confinement element, the second end plug including a third plasma population, the third plasma population configured to form a second electrostatic barrier between the second end plug and the inner region and proximate the second end of the confinement element, and the first electrostatic barrier, and the second electrostatic barrier forming a tandem mirror configured to further confine the first plasma population in the inner region in the axial direction perpendicular to the radial direction.

In some embodiments, a method of using a nuclear fusion reactor including a first confinement element defining a first inner volume configured to contain a first plasma, a second confinement element defining a second inner volume configured to contain a second plasma, the second confinement element proximate to a first axial end of the first confinement element, and a third confinement element defining a third inner volume configured to contain a third plasma, the third confinement element proximate a second axial end of the first confinement element opposite the first axial end, includes: causing the first, second, and third confinement elements to generate corresponding axial magnetic fields, each axial magnetic field at least partially extending along an axial direction of the reactor within each corresponding inner volume; communicating, via a fuel source, a first fuel into the first inner volume to generate the first plasma having a first average electrostatic potential, a second fuel into the second inner volume to generate the second plasma having a second average electrostatic potential, and a third fuel into the third inner volume to generate the third plasma having a third average electrostatic potential, the second and third fuels different from the first fuel, each of the first, second, and third plasmas at least partially radially confined in the first, second, and third inner volumes via the corresponding axial magnetic fields; and heating, via a heat source, the second and third plasma populations such that the second and third average electrostatic potentials are greater than the first average electrostatic potential, the second and third average electrostatic potentials axially confining the first plasma in the inner volume.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of a nuclear fusion reactor in a tandem mirror configuration, including a first confinement element having a first plasma population, a second confinement element having a second plasma population, a third confinement element having a third plasma population, a fuel source, a heat source, and, optionally, a first expander and a second expander, according to an embodiment.

FIG. 2 is a schematic illustration of a nuclear fusion reactor in a tandem mirror configuration, according to an embodiment.

FIG. 3 is a schematic illustration of a nuclear fusion reactor in a tandem mirror configuration and an associated chart displaying plasma potential as a function of axial position in the tandem mirror, according to an embodiment.

FIG. 4 is a schematic flow chart of a method for producing nuclear fusion via a nuclear fusion reactor in a tandem mirror configuration, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to apparatuses and methods for producing nuclear fusion reactions, and, in particular, to a tandem mirror nuclear fusion reactor having a first confinement element having two axial ends, a second confinement element disposed proximate one end of the first confinement element, and a third confinement element disposed proximate the other end of the first confinement element. Each confinement element is configured to contain or hold a plasma population via electromagnetic and/or electrostatic confinement, and particularly, the plasma populations in the second confinement element and the third confinement element form a tandem mirror to confine the plasma population within the first confinement element to promote a fusion reaction therein. Without being bound by theory, the nuclear fusion reactors described herein that include a tandem mirror may increase an axial confinement and/or a confinement duration of the plasma population within the first confinement element. This may, for example, extend the fusion reaction within the first confinement element to improve the total energy generated during the fusion reaction, and, consequently, increase performance of the fusion reactor.

Regulators and legislation across the United States are establishing mandates to accelerate the renewable generation of energy in response to climate change. The US government has also set a goal to zero carbon electricity by 2035, and a zero-carbon economy by 2050. Decarbonization and clean energy procurement targets set by states, utilities, and corporations for the not-so-distant future will require high levels of new renewable energy capacity to be quickly and efficiently integrated into the power grid. Nuclear energy may be key to significantly reducing reliance on fossil fuels, and to generate abundant electrical power for the country and/or the world because the processes themselves generally do not produce greenhouse gases. According to the US Office of Nuclear Energy, nuclear power plants produced 775 billion kilowatt hours of electricity in 2023. Likewise, nuclear power provided about half of the carbon-free electricity produced in the US in 2023, making it the largest source of carbon-free energy in the US.

Currently, nuclear power plants rely on nuclear fission, the splitting of uranium atoms into two smaller atoms which releases heat used to boil water, make steam, and turn turbines or generators to produce electricity. According to the World Nuclear Association, nuclear fission is currently utilized in nuclear power plants around the world to supply nearly 9% of the world's electricity needs. However, the fission process requires scarcely available raw materials (e.g., uranium-235) and produces a significant amount of long-lived radioactive waste as a byproduct, which needs to be managed appropriately to avoid harmful radiation exposure to humans and the environment. According to the World Nuclear Association, deep geological disposal, e.g., at depths of from about 250 meters to about 5,000 meters, is widely considered to be the most effective solution for storage of nuclear waste to prevent radiation exposure to human populations or the surrounding environment. However, creation of these storage sites also requires energy which may largely be from carbon-based fuels.

In contrast, nuclear fusion includes a process by which two or more light atomic nuclei, e.g., deuterium (²H) and tritium (³H), combine to form one heavier atomic nucleus, e.g., helium. The fusion process releases a tremendous amount of energy, which is proportional to the difference in mass between the reactants and the product. Unlike nuclear fission, the fuel sources for nuclear fusion are abundant, and the process itself does not produce a significant amount of long-lived radioactive waste. Various types of nuclear fusion reactors have been studied and developed, such as toroidal systems (e.g., tokamaks, stellarators), laser fusion systems, particle accelerators, and linear fusion reactors, but a stable and repeatable nuclear fusion process for the production of electricity on a commercial scale has yet to be accomplished. Moreover, nuclear fusion also suffers from issues such as plasma instabilities and poor plasma confinement during the fusion reaction, that lead to poor energy generation and has been a hurdle in widespread implementation of nuclear fusion reactors.

To accomplish fusion, high-temperature plasmas generally have to be generated and confined away from a physical container to avoid damage to the container and possible plasma quenching. This may, for example, be achieved by a magnetic mirror confinement system. Magnetic mirror reactors generally include a containment cell having two axial ends and a plasma disposed therein. Magnetic coils are at least partially disposed around the containment cell, which produce a magnetic field therein to at least partially confine the high-temperature plasma. Such confinement systems may provide an axial magnetic field extending between two ends at which the magnetic flux lines converge. Plasma ions moving within this axial magnetic field spiral along the flux lines at the local cyclotron frequency are generally “reflected” by an axial component of magnetic force acting on the spiraling ions. This reflecting axial magnetic force, caused by the flux line convergence and accompanying increasing magnetic field strength, is in the direction away from the convergence, and may be referred to herein as “magnetic mirror effect.” Moreover, the reflecting force, or magnetic mirror effect, is proportional to the particle kinetic energy component which is perpendicular to the magnetic field. A similar reflecting force acts on the plasma electrons.

Nuclear fusion can be promoted in a magnetic mirror confinement system by generating plasma with sufficiently high energy and density. One method of reaching this high-energy and/or density state injects electrically neutral particles (i.e., a neutral beam) through the magnetic mirror confinement field into the plasma confined therein. The neutral particles of the neutral beam are then ionized, that is, split into plasma ions and electrons. The neutral beam has an initial energy above that necessary for fusion so that the resulting plasma ions maintain an energy suitable for fusion even with an expected collisional loss of energy of the plasma ions after introduction into the plasma. The plasma density and energy may be determined by a loss rate of the fast ions, the loss rate decreasing with increasing beam energy. Hence high energy ions are better confined than low energy ions. However, this method of magnetic mirror confinement still allows for plasma ions to escape axially, thereby reducing confinement time within the central cell, and hence, reducing energy generated.

A tandem mirror is a linear fusion reactor including a “central cell” having a plasma therein and end plugs at each end of the central cell, each of which may be independently confined by distinct magnetic mirror confinement fields for the central cell and each end plug. The end plugs are generally configured to induce a high electric potential at each end of the central cell, the electric potential at the end plugs being greater than that in the central cell to form a pair of electrostatic barriers proximate each end of the central cell, thereby increasing the energy required for a plasma ion in the central cell to escape axially. Tandem mirrors were studied heavily up to the early 1980's, but research efforts were halted thereafter due to various issues, such as instabilities in the plasma inside of the central cell and poor plasma confinement during the fusion reaction.

In contrast, embodiments of the apparatus and methods described herein for nuclear fusion in a tandem mirror configuration may provide one or more benefits including, for example: 1) increasing confinement of the plasma in the central cell, 2) providing higher confinement time of the plasma in the central cell, 3) generating more energy via increased confinement and/or confinement time of plasma in the central cell, 4) simplifying end plug engineering, 5) avoiding nuclear fusion in the end plugs, 6) simplifying waste stream associated with nuclear fusion products of end plugs, 7) increasing electrostatic potential of plasma in the end plugs, 8) enabling use of unblanketed end plugs as the plugs will no longer contribute to meaningfully to tritium fuel burn, 9) simplifying end plug magnets by reducing amount of shielding use, and, thus, reducing bore sizes, and/or 10) increasing end plug ion confinement.

In some embodiments, a tandem mirror is a device which generally includes a “central cell” having a plasma population therein and two “end plugs,” each of which may be independently confined by the magnetic mirror effect. The end plugs may each include plasma population which may be configured to induce a large electric potential at each end of the central cell to confine the plasma in the central cell. The plasma populations confined in each region of the nuclear fusion reactor/tandem mirror may effectively be distinct from one another, i.e., an ion lost in one region will generally not be confined in the other, and each region may be fueled independently, for example, the central cell with gas puffing and the end-plug with neutral beam injection (NBI). Therefore, their ion composition need not be the same. The electric potential between the central cell and the end plugs may be defined as:

$${ϕ}_{i} = {T}_{e} ln \frac{{n}_{p}}{{n}_{c}}$$

where Tₑ is the electron temperature, nₚ is the end-plug density, and n_{c} is the central-cell density. To design a successful tandem mirror, it is desirable to maximize φᵢ which confines the central cell, for example, by increasing Tₑ and nₚ to the greatest extent possible while using the minimum amount of heating power delivered to the end plugs. To do this, it is desirable to maximize the axial confinement in the end plug. Axial ion confinement by the magnetic mirror effect, i.e., magnetic mirror confinement fields, in a tandem mirror end plug may be determined by two processes, ion-ion scattering and electron drag losses. The particle confinement times associated with these two processes may be defined as follows:

$${τ}_{s} = 2.76 \times {10}^{18} {μ}^{1 / 2} {E}_{EBI}^{3 / 2} \frac{{log}_{10} ( {R}_{m} {sin}^{2} {θ}_{NBI} )}{{n}_{p} {Z}^{4} ln {Λ}_{ii}}$$

$${τ}_{d} = 1 \times {10}^{14} {μT}_{e}^{3 / 2} \frac{ln ( {E}_{NBI} / {E}_{L} )}{{n}_{p} {Z}^{2} ln {Λ}_{ei}}$$

$${τ}_{p} \approx {( 1 / {τ}_{s} \times 1 / {τ}_{d} )}^{- 1}$$

where τₛ is the confinement time associated with scattering (measured in seconds), τ_{d} is the confinement time associated with drag (measured in seconds), τₚ is the overall confinement time, μ is the ion mass of the ions in the plug in atomic mass units, E_{NBI} is the energy of the NBI, Z is the ion charge, ln Λ˜20 is the Coulomb logarithm, Rₘ is the mirror ratio of the end-plug (i.e., the ratio of the peak at the end of the mirror and the minimum field at the center of the mirror), and the average ion loss energy may be defined by a combination of the two loss energies associated with electron drag and scattering:

$${E}_{L} \approx \frac{1}{1 + ( {τ}_{s} / {τ}_{d} )} [ {E}_{NBI} + {E}_{h} ( \frac{{τ}_{s}}{{τ}_{d}} ) ]$$

with ambipolar hole energy:

$${E}_{h} = \frac{{ϕ}_{p}}{{R}_{m} {sin}^{2} {θ}_{NBI} - 1} ,$$

where φₚ˜5Tₑ is the ambipolar electric potential in the end-plug. At typical tandem operational parameters, confinement is electron drag dominated, τ_{d}«τₛ and therefore τₚ˜τ_{d}. The important result of these equations is that end plug confinement improves with increasing ion mass over charge-squared ratio: μ/Z².

In addition, choosing an end plug ion mixture with a low fusion cross-section to suppress fusion neutron generation in the end plug can substantially simplify the nuclear engineering in the end plug. Suppressing fusion rates in the end plugs may be desirable as the fusion power derived from the end plug is a small component of the overall fusion power output in a tandem mirror. This is because the end plug volume Vₚ is much less than central cell volume V_{c}, i.e., Vₚ«V_{c}. Despite being small, the end plug may have many sensitive components and more complicated geometry than the central cell, making the nuclear engineering there more complicated if large fusion neutron rates are present.

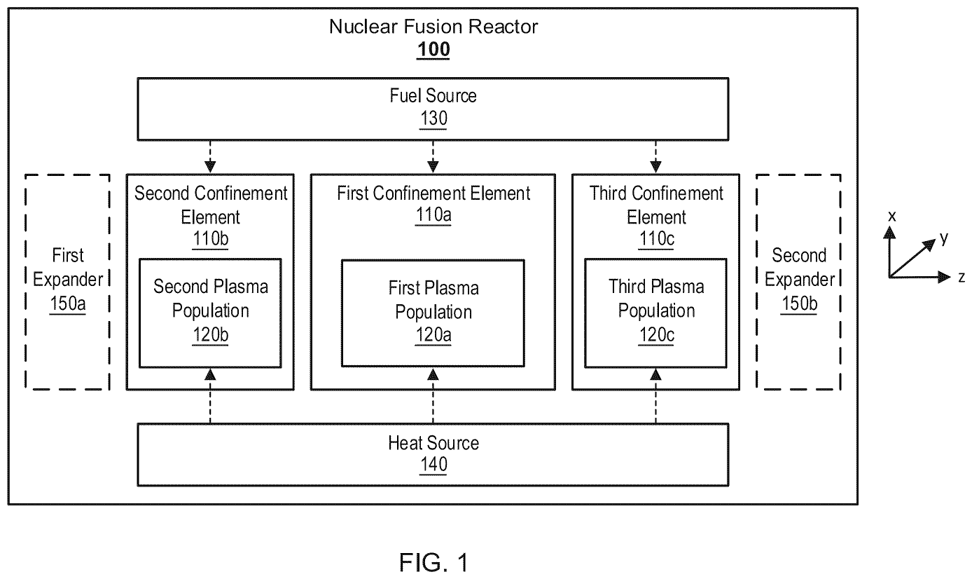

FIG. 1 is a schematic illustration of a nuclear fusion reactor 100, according to an embodiment. The nuclear fusion reactor 100 (also referred to herein as “reactor 100”) includes a first confinement element 110a, a second confinement element 110b, and a third confinement element 110c (collectively referred to herein as “confinement element(s) 110”). The nuclear fusion reactor 100 further includes a first plasma population 120a, a second plasma population 120b, and a third plasma population 120c (collectively referred to herein as “plasma population(s) 120”). In some embodiments, the plasma population(s) 120 may each include an ion (i.e., positively charged ion) and an electron (i.e., negatively charged electron). In some embodiments, the first confinement element 110a includes the first plasma population 120a disposed therein, the second confinement element 110b includes the second plasma population 120b disposed therein, and the third confinement element 110c includes the third plasma population 120c disposed therein.

The nuclear fusion reactor 100 further includes a fuel source 130 and/or a heat source 140. In some embodiments, the fuel source 130 is configured to supply fuel to at least one of the first plasma population 120a, the second plasma population 120b, and the third plasma population 120c. In some embodiments, the heat source 140 is configured to heat at least one of the first plasma population 120a, the second plasma population 120b, and the third plasma population 120c. In some embodiments, the nuclear fusion reactor 100 can optionally include a first expander 150a and a second expander 150b (collectively referred to herein as “expander(s) 150”). In some embodiments, the expander(s) 150 are configured to stabilize at least one of the first, second, or third plasma populations 120a, 120b, 120c. In some embodiments, the nuclear fusion reactor 100 can optionally direct one or more axially escaping ion(s) to an optional direct energy conversion system (not shown) disposed axially outside the expanders 150a and 150b. In some embodiments, each plasma population 120a, 120b, 120c may include a corresponding ion population that includes one or more ions, and a corresponding electron population that includes one or more electrons.

For reference, FIG. 1 shows a cartesian coordinate system having three perpendicular axes, i.e., an x-axis (i.e., a vertical direction), a y-axis (i.e., a horizontal direction), and a z-axis (i.e., an axial direction defined along a central axis of the nuclear fusion reactor 100 and extending along an axial length thereof). In some embodiments, the x-direction, the y-direction, or a combination thereof may be referred to as a “radial direction.” In some embodiments, directions in the reactor 100 may be referred to in terms of a cylindrical coordinate system (r, θ, z), for example, including a radial distance r (also referred to as the “radial direction”), a distance z along the z-axis extending along the axial length of the reactor 100 (also referred to as the “axial direction”), and an angle θ to a reference direction (also referred to as the “azimuthal direction”).

The confinement element(s) 110 may each be configured to confine corresponding plasma population(s) 120 disposed therein. In some embodiments, each confinement element 110a, 110b, 110c may at least partially define a corresponding inner region (not shown) (collectively referred to as “inner region(s)”), the inner region(s) configured to have the corresponding plasma population(s) 120 disposed therein. In some embodiments, the inner region(s) may be configured to contain the corresponding plasma population(s) 120. In some embodiments, each inner region may also be referred to as a “confinement region,” a “confinement volume,” a “containment region,” a “plasma containment volume,” or an “inner volume.”

In some embodiments, confinement element(s) 110 may be configured to allow fuel from the fuel source 130 to enter the corresponding inner region(s) to enable fueling of the corresponding plasma population(s) 120 disposed therein. In some embodiments, the fuel source 130 and/or the fuel may include particles or ions of at least one of protium (i.e., hydrogen, H), deuterium (H-2), tritium (H-3), helium (He), helium isotopes (e.g., ³He or +He), lithium (Li), lithium isotopes (e.g., Li-6 or Li-7), beryllium (Be), beryllium isotopes (e.g., Be-9 or Be-10), boron (B), boron isotopes (e.g., B-10 or B-11), carbon (C), carbon isotopes (e.g., C-12, C-13, or C-14), or any other suitable elements or isotopes thereof. In some embodiments, confinement element(s) 110 may be configured to allow heat from the heat source 140 to enter the corresponding inner region(s) to enable heating of the corresponding plasma population(s) 120 disposed therein. In some embodiments, the inner region(s) may be configured to receive fuel from the fuel source 130 to enable fueling of the plasma population(s) 120 disposed therein. In some embodiments, the inner region(s) may be configured to receive heat from the heat source 140 to enable heating of the corresponding plasma population(s) 120 disposed therein.

In some embodiments, the first confinement element 110a may include a first axial end and a second axial end (not shown), each of the second confinement element 110b and the third confinement element 110c disposed proximate one of the axial ends of the first confinement element 110a. For example, the second confinement element 110b may be disposed proximate the first axial end of the first confinement element 110a, and the third confinement element 110c may be disposed proximate the second axial end of the first confinement element 110a. In some embodiments, the second confinement element 110b may be disposed proximate the second axial end of the first confinement element 110a, and the third confinement element 110c may be disposed proximate the first axial end of the first confinement element 110a. In some embodiments, the second confinement element 110b and the third confinement element 110c may be disposed proximate corresponding axial ends of the first confinement element 110a. In some embodiments, the second confinement element 110b and the third confinement element 110c may be disposed outside the first confinement element 110a. In some embodiments, the first confinement element 110a may include axially spaced apart first rings that are configured to generate a magnetic field, for example, when energized by electrical energy (e.g., generate an electromagnetic field). In some embodiments, the first rings may have the same diameter. In other embodiments, the first rings may have varying diameters, for example, larger diameter rings located in the center and rings with smaller diameters located axially spaced apart on either side of the center ring(s), with the smallest diameter rings disposed at the first and second axial ends.

In some embodiments, each of the second confinement element 110b and the third confinement element 110c (may be collectively referred to herein as “end confinement elements 110b/c”) may include axial ends which may be distinct from the axial ends of the first confinement element 110a. For example, in some embodiments, the second confinement element 110b may include a first axial end and a second axial end thereof, and the third confinement element 110c may include a first axial end and a second axial end thereof. In some embodiments, the first axial end and second axial end of the second confinement element 110b may be referred to as a third axial end and a fourth axial end, respectively, while the first axial end and the second axial end of the third confinement element 110c may be referred to as a fifth axial end and a sixth axial end, respectively, or vice versa. In some embodiments, the second and third confinement elements 110b and 110c may each include a pair of rings axially spaced apart from each other and configured to generate a magnetic field therebetween when energized by electrical energy.

In some embodiments, the first confinement element 110a may be referred to as “central cell” or “central chamber.” In some embodiments, the second confinement element 110b may be referred to as a “first end plug” and the third confinement element 110c may be referred to as a “second end plug,” or vice versa. In some embodiments, the second confinement element 110b and the third confinement element 110c may be collectively referred to as “end confinement elements,” “end cells,” or “end plugs.”

In some embodiments, each of the confinement elements 110a, 110b, and 110c may have corresponding axial length(s) and/or corresponding axial end(s) thereof. In some embodiments, the confinement element(s) 110 may be configured to confine corresponding plasma population(s) 120 therein via corresponding axial magnetic fields and corresponding magnetic mirror confinement field(s) (i.e., “magnetic mirror effect(s)”). For example, at least one of the confinement element(s) 110 may be configured to confine the corresponding plasma population(s) 120 therein via an axial magnetic field(s). The axial magnetic field may have a magnetic field strength and at least one magnetic flux line extending between axial ends thereof. In some embodiments, the axial magnetic field may be configured to enable travel of the one or more ions along at least one of the magnetic flux lines. In some embodiments, the magnetic flux lines may enable travel of the ion, or the plurality of ions, along the magnetic flux lines in an axial direction. In some embodiments, the confinement element(s) 110 may be configured to produce the axial magnetic field between corresponding axial ends thereof and/or generate a magnetic mirror effect proximate to each axial end thereof. The axial magnetic field may be configured to at least partially confine the first plasma population in the inner region along a radial direction, and to generate the magnetic mirror effect configured to at least partially confine the first plasma population 120a in the inner region along the axial direction perpendicular to the radial direction.

The confinement element(s) 110 may each include a magnet (not shown) configured to produce or generate a magnetic field. In some embodiments, the confinement element(s) 110 may include a permanent magnet (not shown), an electromagnet (not shown), or a combination thereof. In some embodiments, the confinement element(s) 110 may include an electromagnetic coil (not shown) (e.g., a solenoid, also referred to as “solenoid coil”). For example, the electromagnetic coil may be formed of an electrically conductive material (e.g., electrically conductive metal) wound into a coil and configured to receive a flow of electrons (e.g., an electric current) from a power source (e.g., electricity source) and/or transport the flow of electrons therethrough to produce the magnetic field.

In some embodiments, the magnetic field may include an axial component (i.e., along the z-axis), which may also be referred to as an “on-axis.” In some embodiments, the magnetic field may include an off-axis component, such as component in a direction offset from the z-axis (e.g., having a component in the x-direction, y-direction, or a combination thereof, or having a radial component in the r-direction with a corresponding angle θ). In other words, in some embodiments, for example, in which the reactor 100 includes non-axisymmetric coils in the confinement element(s) 110 (e.g., minimum-B coils), the magnetic field may have an azimuthal component (i.e., a component in the azimuthal direction). For example, in some embodiments, the magnetic field may include magnetic field lines extending at least partially in the axial direction, at least partially in the radial direction, at least partially in the azimuthal direction, or a combination thereof. In some embodiments, the magnetic field may include axially extending magnetic flux lines, for example, at least partially extending between a first end and a second end of a corresponding electromagnetic coil and/or confinement element(s) 110.

In some embodiments, the electromagnetic coil may be incorporated (e.g., included, disposed, contained) in the confinement element(s) 110. In some embodiments, the confinement element(s) 110 may be disposed within the electromagnetic coil (e.g., the electromagnetic coil may be disposed around the confinement element(s) 110). In some embodiments, the confinement element(s) 110 may be disposed around the electromagnetic coil.

In some embodiments, each of the confinement element(s) 110 may include a solenoid, a high-field coil, or a combination thereof. In other words, the electromagnetic coil may be a solenoid or a high-field coil. In some embodiments, the solenoid may be configured to produce an axial magnetic field along the axial direction defined along the central axis through the nuclear fusion reactor 100. For example, the axial magnetic field produced by the solenoid may extend between a first end and a second end of at least one of the confinement element(s) 110. The solenoid and/or the axial magnetic field may be configured to at least partially confine at least one of the plasma population(s) 120 in the radial direction. In some embodiments, the electromagnetic coil may be a high-field coil. In some embodiments, the high-field coil may be configured to generate a magnetic mirror effect to at least partially confine at least one of the plasma population(s) 120 in the axial direction. In some embodiments, the magnetic mirror effect may, for example, be generated proximate an axial end of at least one of the confinement element(s) 110.

In some embodiments, each of the confinement element(s) 110 may include a plurality of magnets and/or a plurality of electromagnets. For example, in some embodiments, the confinement element(s) 110 may each include a plurality of electromagnetic coils, such as a one or more solenoids, one or more high-field coils, or a combination thereof. In some embodiments, confinement element(s) 110 may include a combination of one or more solenoid(s) and one or more high-field coil(s) configured to confine corresponding plasma population(s) 120 therein via a combination of the axial magnetic field (e.g., generated by the solenoid) and the magnetic mirror effect (e.g., generated by the high-field coils).

In some embodiments, the axial magnetic field(s) (e.g., generated by at least one of the confinement element(s) 110) may be configured to confine each plasma population 120 in the radial direction and at least partially in the axial direction. For example, without being bound by theory, the axial magnetic field may generate a radial magnetic force perpendicular to the axial direction, the radial magnetic force configured to confine the plasma population(s) 120 in the radial direction. In some embodiments, the axial magnetic field(s) and/or radial magnetic force(s) may be configured to prevent ions from escaping the confinement element(s) 110 in the radial direction. In some embodiments, the axial magnetic field may have a plurality of magnetic flux lines configured to converge proximate axial ends of at least one of the confinement element(s) 110 thereby enabling an ion traveling in a first axial direction in at least one of the plasma populations 120 to travel in a second axial direction. This may be referred to as the “magnetic mirror effect” and may at least partially enable confinement of the ions and/or the plasma population(s) 120 disposed in the corresponding confinement element 110 in the axial direction.

For example, in some embodiments, the ions traveling within the axial magnetic field may spiral along the magnetic flux lines at a local cyclotron frequency. In some embodiments, the convergence of the magnetic flux lines proximate the axial ends of the corresponding confinement element 110a, 110b, or 110c, may create a magnetic force acting on the ion spiraling along the magnetic flux line at the local cyclotron frequency, the magnetic force having an axial component and being configured to act on the ion in the axial direction away from convergence of the magnetic flux lines. In some embodiments, the convergence of the magnetic flux lines may increase the magnetic field strength proximate the axial end of the corresponding confinement element(s) 110. In some embodiments, the spiraling ion may be “reflected” by a reflecting magnetic force acting on the spiraling ion, the reflecting magnetic force having an axial component of the magnetic force acting on the spiraling ion in a direction opposite the convergence of the magnetic flux lines. In some embodiments, the reflecting magnetic force may be caused by the magnetic flux line convergence and accompanying increasing magnetic field strength in the direction away from the convergence. The reflecting force may be proportional to the particle kinetic energy component which is perpendicular to the magnetic field. In some embodiments, a similar reflecting force may act on one or more plasma electrons in the corresponding plasma population 120.

In some embodiments, the first confinement element 110a may have axial ends, the first confinement element 110a at least partially defining the inner region configured to have the first plasma population 120a disposed, contained, or held therein. The first confinement element 110a is configured to produce a first axial magnetic field between the axial ends thereof configured to confine the first plasma population 120a in the first confinement element 110a in the radial direction. In some embodiments, the first axial magnetic field generates a first magnetic mirror effect at each axial end of the first confinement element 110a to at least partially confine the first plasma population 120a in the first confinement element 110a in the axial direction. The first plasma population 120a may include a plasma generated from a fusion source or raw material, such as hydrogen isotopes (e.g., deuterium and/or tritium).

The second confinement element 110b is disposed outside the first confinement element 110a, i.e., outside of the inner region defined by the first confinement element 110a proximate the first axial end thereof. The second confinement element 110b at least partially defines a second inner region that is configured to have the second plasma population 120b disposed, contained, or held therein. The second confinement element 110b is configured to produce a second axial magnetic field between the axial ends thereof. The second axial magnetic field is configured to generate a second magnetic mirror effect to at least partially confine the second plasma population 120b in the second confinement element 110b. Similarly, the third confinement element 110c is disposed outside the first confinement element 110b proximate the second axial end thereof. The third confinement element 110c is configured to produce a third axial magnetic field between the axial ends thereof. The third axial magnetic field is configured to generate a third magnetic mirror effect to at least partially confine the third plasma population 120c in the third confinement element 110c.

The plasma population(s) 120 may each contain or include ions (e.g., positively charged ions) and electrons (e.g., negatively charged electrons). In some embodiments, a leakage rate of the electrons exceeds a leakage rate of ions from each plasma population 120. In this case, the confinement element(s) 110 may each have an associated positive electrostatic potential determined by a relative ratio of positively charged ions to negatively charged electrons. In other words, the plasma population(s) 120 may each have (e.g., generate, include, produce, etc.) a corresponding positive electrostatic potential (may also be referred to herein as “electrostatic potential,” “electric potential,” and/or “plasma potential”). In some embodiments, the positive electrostatic potential may balance the ion and electron leakage rates and/or densities. The positive potential developed in one or both the second confinement element 110b and the third confinement elements 110c may suppress the axial leakage rate of ions from the first confinement element 110a through each respective axial end of the first confinement element 110a. In this manner, while the first axial magnetic field at least partially confines the first plasma population 120a in the axial direction via the magnetic mirror effect, any leakage of positively charged ions in the first plasma population 120a along the axial direction, for example, at the axial ends of the first confinement element 110a, is further inhibited by the second and third axial electrostatic potentials. This advantageously increases confinement of positively charged ions in the first plasma population 120a in the axial direction thereby increasing retention time and efficiency of the fusion reaction occurring within the inner region.

As previously described, in some embodiments, each confinement element(s) 110 may include one or more electromagnetic coils, such as solenoids (e.g., solenoid coils), high-field coils, or a combination thereof. In some embodiments, the solenoids (e.g., solenoid coils or axially-extending solenoid coils) may be configured to at least partially confine one or more of the plasma population(s) 120 within one or more of the corresponding confinement element(s) 110 in the radial direction. For example, the solenoid coils (e.g., axially-extending solenoid coils) may be configured to generate the axial magnetic fields to at least partially confine the ions and/or the plasma population(s) 120 in the radial direction. In some embodiments, the nuclear fusion reactor 100 may include a combination of high-field coils and solenoid coils. For example, in some embodiments, the first confinement element 110a may include axially-extending solenoid coil(s) while the second confinement element 110b and the third confinement element 110c may include high-field coils. In some embodiments, the electromagnetic coils, i.e., the solenoids, the high-field coils, or a combination thereof, may include or be formed of superconducting magnets. The superconducting magnets may, for example, be formed of a high-temperature superconductor, such as a rare-earth oxide, for example, a rare-earth barium copper oxide, such as yttrium barium copper oxide (YBCO).

In some embodiments, each of the confinement element(s) 110 generates a corresponding axial magnetic field having a corresponding magnetic field strength. Each magnetic field strength may vary at different points along the axial direction and/or the radial direction of each confinement element 110. In some embodiments, the magnetic field strength along the z-axis, defined centrally through the reactor 100 in the axial direction, may be referred to as the “on-axis magnetic field strength.”

In some embodiments, the on-axis magnetic field strength of any of the confinement element(s) 110 may be in a range of about 1 T to about 35 T, inclusive of all values and ranges therebetween. For example, in some embodiments, the on-axis magnetic field strength may be about 1 T, about 2 T, about 3 T, about 4 T, about 5 T, about 6 T, about 7 T, about 8 T, about 9 T, about 10 T, about 11 T, about 12 T, about 13 T, about 14 T, about 15 T, about 16 T, about 17 T, about 18 T, about 19 T, about 20 T, about 21 T, about 22 T, about 23 T, about 24 T, about 25 T, about 26 T, about 27 T, about 28 T, about 29 T, about 30 T, about 31 T, about 32 T, about 33 T, about 34 T, or about 35 T, inclusive of all values and ranges therebetween. In some embodiments, the on-axis magnetic field strength may be at least about 1 T, at least about 2 T, at least about 3 T, at least about 4 T, at least about 5 T, at least about 6 T, at least about 7 T, at least about 8 T, at least about 9 T, at least about 10 T, at least about 11 T, at least about 12 T, at least about 13 T, at least about 14 T, at least about 15 T, at least about 16 T, at least about 17 T, at least about 18 T, at least about 19 T, at least about 20 T, at least about 21 T, at least about 22 T, at least about 23 T, at least about 24 T, at least about 25, at least about 26 T, at least about 27 T, at least about 28 T, at least about 29 T, at least about 30 T, at least about 31 T, at least about 32 T, at least about 33 T, or at least about 34 T. In some embodiments, the on-axis magnetic field strength may be no more than about 35 T, no more than about 34 T, no more than about 33 T, no more than about 32 T, no more than about 31 T, no more than about 30 T, no more than about 29 T, no more than about 28 T, no more than about 27 T, no more than about 26 T, no more than about 25 T, no more than about 24 T, no more than about 23 T, no more than about 22 T, no more than about 21 T, no more than about 20 T, no more than about 19 T, no more than about 18 T, no more than about 17 T, no more than about 16 T, no more than about 15 T, no more than about 14 T, no more than about 13 T, no more than about 12 T, no more than about 10 T, no more than about 9 T, no more than about 8 T, no more than about 7 T, no more than about 6 T, no more than about 5 T, no more than about 4 T, no more than about 3 T, or no more than about 2 T. Combinations of the above-referenced on-axis magnetic field strength(s) are also possible (e.g., on-axis magnetic field strength of at least about 1 T and no more than about 35 T, or at least about 3 T and no more than about 25 T), inclusive of all values and ranges therebetween. While values and ranges for on-axis magnetic field strength(s) have been described above, magnetic field strength(s) at a radial distance off the z-axis (referred to herein as “off-axis magnetic field strengths”), may increase beyond the ranges described above.

In some embodiments, the on-axis magnetic field strength(s) may be different under vacuum (referred to herein as “on-axis vacuum magnetic field strength”), for example, by incorporating one or more vacuum pump(s) (not shown) into the reactor 100. In some embodiments, the vacuum pump(s) may be any vacuum pump or combination of vacuum pumps suitable for establishing and/or maintaining at least an ultra-high vacuum (UHV) within one or more of the confinement element(s) 110 to enable fusion. In some embodiments, the vacuum pump(s) may be configured to draw a vacuum on the confinement element(s) 110 to enable reduction of a pressure therein to a vacuum pressure within the confinement element(s) 110. In some embodiments, the vacuum pump(s) may be configured to evacuate excess air from the confinement element(s) 110. In some embodiments, the vacuum pump(s) may be configured to evacuate undesired particles from the confinement element(s) 110. In some embodiments, the vacuum pump(s) may be configured to sustain the vacuum pressure during the fusion reaction. In some embodiments, decreasing the pressure within the confinement element(s) 110 to the vacuum pressure may prevent contamination of and/or help stabilize the plasma population(s) 120 within the confinement element(s) 110 during the fusion reaction.

In some embodiments, the on-axis vacuum magnetic field strength of any of the confinement element(s) 110 may be in a range of about 1 T to about 35 T. In some embodiments, the on-axis vacuum magnetic field strength may be about 1 T, about 2 T, about 3 T, about 4 T, about 5 T, about 6 T, about 7 T, about 8 T, about 9 T, about 10 T, about 11 T, about 12 T, about 13 T, about 14 T, about 15 T, about 16 T, about 17 T, about 18 T, about 19 T, about 20 T, about 21 T, about 22 T, about 23 T, about 24 T, about 25 T, about 26 T, about 27 T, about 28 T, about 29 T, about 30 T, about 31 T, about 32 T, about 33 T, about 34 T, or about 35 T, inclusive of all values and ranges therebetween. In some embodiments, the on-axis vacuum magnetic field strength may be at least about 1 T, at least about 2 T, at least about 3 T, at least about 4 T, at least about 5 T, at least about 6 T, at least about 7 T, at least about 8 T, at least about 9 T, at least about 10 T, at least about 11 T, at least about 12 T, at least about 13 T, at least about 14 T, at least about 15 T, at least about 16 T, at least about 17 T, at least about 18 T, at least about 19 T, at least about 20 T, at least about 21 T, at least about 22 T, at least about 23 T, at least about 24 T, at least about 25, at least about 26 T, at least about 27 T, at least about 28 T, at least about 29 T, at least about 30 T, at least about 31 T, at least about 32 T, at least about 33 T, or at least about 34 T. In some embodiments, the on-axis vacuum magnetic field strength may be no more than about 35 T, no more than about 34 T, no more than about 33 T, no more than about 32 T, no more than about 31 T, no more than about 30 T, no more than about 29 T, no more than about 28 T, no more than about 27 T, no more than about 26 T, no more than about 25 T, no more than about 24 T, no more than about 23 T, no more than about 22 T, no more than about 21 T, no more than about 20 T, no more than about 19 T, no more than about 18 T, no more than about 17 T, no more than about 16 T, no more than about 15 T, no more than about 14 T, no more than about 13 T, no more than about 12 T, no more than about 11 T, no more than about 10 T, no more than about 9 T, no more than about 8 T, no more than about 7 T, no more than about 6 T, no more than about 5 T, no more than about 4 T, no more than about 3 T, or no more than about 2 T. Combinations of the above-referenced on-axis vacuum magnetic field strength(s) are also possible (e.g., on-axis vacuum magnetic field strength of at least about 1 T and no more than about 35 T, or at least about 3 T and no more than about 25 T), inclusive of all values and ranges therebetween. While values and ranges for on-axis vacuum magnetic field strength(s) have been described above, vacuum magnetic field strength(s) at a radial distance off the z-axis (referred to herein as “off-axis vacuum magnetic field strengths”), may increase beyond the ranges described above.

In some embodiments, the vacuum magnetic field strength may vary along a length of the confinement elements 110, i.e., along the z-axis, and may also vary along a radial direction (e.g., in the x and/or y directions). In some embodiments, the confinement elements 110 may have a vacuum magnetic field strength of at least about 20 T along the z or central axis of the confinement elements 110 at a central point of the confinement elements 110 (e.g., a location of the coils in the confinement elements 110 generating the highest magnetic field). The vacuum magnetic field strength may decrease along the z-axis in the axial direction such that the vacuum field strength may be less than 5T at locations furthest away from central location (e.g., proximate to axial ends of the respective confinement elements 110. In some embodiments, the magnetic field may increase along the radial direction away from the z-axis. In other words, the magnetic field increase at locations offset from the central or z-axis, for example, to have a magnitude of greater than 25 T at radial locations furthest away from the central axis.

In some embodiments, the pressure may vary as the vacuum pump(s) evacuate the confinement element(s) 110 and/or corresponding inner region(s) thereof. For example, before, during, or after evacuation of the confinement element(s) 110, the pressure in the confinement element(s) 110 may vary with a vacuum level ranging from atmospheric pressure (e.g., about 101 kPa), low (roughing) vacuum (e.g., about 3 kPa to about 100 kPa), medium vacuum (e.g., about 100 mPa to about 3 kPa), high vacuum (e.g., about 100 nPa to about 100 mPa), ultra-high vacuum (e.g., about 100 pPa to about 100 nPa), or extremely high vacuum (e.g., less than about 100 pPa). However, in some embodiments, such as during operation of the reactor 100 (e.g., when preparing for the fusion reaction and/or during the fusion reaction), the vacuum level may be in a range from high vacuum to extremely high vacuum.

In some embodiments, the vacuum pressure during operation of the reactor 100 may be in a range of about 1 picopascal (pPa) to about 0.1 millipascal (mPa) (i.e., about 1 microtorr), inclusive of all values and ranges therebetween. For example, in some embodiments, the vacuum pressure during operation of the reactor 100 may be about 1 pPa, about 10 pPa, about 50 pPa, about 100 pPa, about 150 pPa, about 200 pPa, about 250 pPa, about 300 pPa, about 350 pPa, about 400 pPa, about 450 pPa, about 500 pPa, about 550 pPa, about 600 pPa, about 650 pPa, about 700 pPa, about 750 pPa, about 800 pPa, about 850 pPa, about 900 pPa, about 950 pPa, about 1000 pPa (i.e., about 1 nPa), about 10 nPa, about 50 nPa, about 100 nPa, about 200 nPa, about 300 nPa, about 400 nPa, about 500 nPa, about 600 nPa, about 700 nPa, about 800 nPa, about 900 nPa, about 1000 nPa (i.e., about 1 micropascal (μPa)), about 10 μPa, about 20 μPa, about 30 μPa, about 40 μPa, about 50 μPa, about 60 μPa, about 70 μPa, about 80 μPa, about 90 μPa, or about 100 μPa (i.e., 0.1 mPa), inclusive of all values and ranges therebetween.

In some embodiments, the vacuum pressure during operation of the reactor 100 may be at least about 1 pPa, at least about 10 pPa, at least about 50 pPa, at least about 100 pPa, at least about 150 pPa, at least about 200 pPa, at least about 250 pPa, at least about 300 pPa, at least about 350 pPa, at least about 400 pPa, at least about 450 pPa, at least about 500 pPa, at least about 550 pPa, at least about 600 pPa, at least about 650 pPa, at least about 700 pPa, at least about 750 pPa, at least about 800 pPa, at least about 850 pPa, at least about 900 pPa, at least about 950 pPa, at least about 1000 pPa (i.e., at least about 1 nPa), at least about 10 nPa, at least about 50 nPa, at least about 100 nPa, at least about 200 nPa, at least about 300 nPa, at least about 400 nPa, at least about 500 nPa, at least about 600 nPa, at least about 700 nPa, at least about 800 nPa, at least about 900 nPa, at least about 1000 nPa (i.e., at least about 1 micropascal (μPa)), at least about 10 μPa, at least about 20 μPa, at least about 30 μPa, at least about 40 μPa, at least about 50 μPa, at least about 60 μPa, at least about 70 μPa, at least about 80 μPa, or at least about 90 μPa.

In some embodiments, the vacuum pressure during operation of the reactor 100 may be no more than about 100 μPa (i.e., no more than about 0.1 mPa or 1 μtorr), no more than about 90 μPa, no more than about 80 μPa, no more than about 70 μPa, no more than about 60 μPa, no more than about 50 μPa, no more than about 40 μPa, no more than about 30 μPa, no more than about 20 μPa, no more than about 10 μPa, no more than about 1 μPa (i.e., no more than about 1000 nPa), no more than about 900 nPa, no more than about 800 nPa, no more than about 700 nPa, no more than about 600 nPa, no more than about 500 nPa, no more than about 400 nPa, no more than about 300 nPa, no more than about 200 nPa, no more than about 100 nPa, no more than about 50 nPa, no more than about 10 nPa, no more than about 1 nPa (i.e., no more than about 1000 pPa), no more than about 950 pPa, no more than about 900 pPa, no more than about 850 pPa, no more than about 800 pPa, no more than about 750 pPa, no more than about 700 pPa, no more than about 650 pPa, no more than about 600 pPa, no more than about 550 pPa, no more than about 500 pPa, no more than about 450 pPa, no more than about 400 pPa, no more than about 350 pPa, no more than about 300 pPa, no more than about 250 pPa, no more than about 200 pPa, no more than about 150 pPa, no more than about 100 pPa, no more than about 50 pPa, or no more than about 10 pPa, inclusive of all values and ranges therebetween.

Combinations of the aforementioned vacuum pressures during operation of the reactor 100 are also possible (e.g., at least about 1 pPa and no more than about 0.1 mPa, or at least about 10 pPa and no more than about 1 μPa), inclusive of all values and ranges therebetween.

In some embodiments, the nuclear fusion reactor 100 includes the first plasma population 120a, the second plasma population 120b, and the third plasma population 120c (collectively referred to as “plasma population(s) 120,” as previously described). The first plasma population 120a is disposed in the first confinement element 110a, the second plasma population 120b is disposed in the second confinement element 110b, and the third plasma population 120c is disposed in the third confinement element 110c. In some embodiments, the first plasma population 120a may be disposed in the inner region of the first confinement element 110a, the second plasma population 120b may be disposed in the inner region of the second confinement element 110b, and the third plasma population 120c may be disposed in the inner region of the third confinement element. In some embodiments, first plasma population 120a, the second plasma population 120b, and the third plasma population 120c may include a first thermal plasma, a second thermal plasma, and a third thermal plasma, respectively. In some embodiments, the first plasma population 120a may be referred to as “the first plasma,” the second plasma population 120b may be referred to as “the second plasma,” and the third plasma population 120c may be referred to as “the third plasma.”

In some embodiments, the first plasma population 120a may be generated inside the first confinement element 110a, the second plasma population 120b may be generated inside the second confinement element 110b, and the third plasma population 120c may be generated inside the third confinement element 110c. For example, at least one of the plasma populations may be generated by disposing a gas population inside at least one of the confinement elements via the fuel source 130 and heating the gas population via the heat source 140 to form the ion population and the electron population, the ion population and the electron population forming the plasma population. In some embodiments, a first gas population may be disposed in the first confinement element 110a, a second gas population may be disposed in the second confinement element 110b, and a third gas may be disposed in the third confinement element 110c. In some embodiments, the first gas population may be referred to as “the first gas,” the second gas population may be referred to as “the second gas,” and the third gas population may be referred to as “the third gas.”

In some embodiments, the first gas population, the second gas population, and the third gas population (collectively referred to herein as “the gas populations”) may be formed from the fuel source 130 and heated via the heat source 140 to generate the first plasma population 120a, the second plasma population 120b, and the third plasma population 120c, respectively. In some embodiments, at least one of the gas population(s) and/or one or more of the plasma population(s) 120 may include particles or ions of protium (i.e., hydrogen, H), deuterium (H-2), tritium (H-3), helium (He), helium isotopes (e.g., He-3 or He-4), lithium (Li), lithium isotopes (e.g., Li-6 or Li-7), beryllium (Be), beryllium isotopes (e.g., Be-9 or Be-10), boron (B), boron isotopes (e.g., B-10 or B-11), carbon (C), carbon isotopes (e.g., C-12, C-13, or C-14), any other suitable elements or isotopes thereof, or a combination thereof.

In some embodiments, at least one of the gas population(s) and/or at least one of the plasma population(s) 120 may be formed substantially of protium, deuterium, tritium, or a combination thereof. In some embodiments, the first gas population may be formed of deuterium and/or tritium (e.g., combination of deuterium and tritium), and the second gas population and third gas population may be formed substantially of tritium (e.g., second gas population and third gas population formed substantially of tritium and substantially free from deuterium). Accordingly, in some embodiments, the second plasma population 120b and the third plasma population 120c may be formed substantially of a combination of particles and/or ions of tritium and electrons. In other words, in some embodiments, the second and third plasma populations 120b, 120c may include ions formed substantially of tritium and/or substantially free of deuterium. In such embodiments, the second plasma population 120b and the third plasma population 120c may include only one nuclear material (e.g., tritium). In such embodiments, nuclear reactions and/or byproducts thereof in the second and third plasma populations 120b, 120c may be suppressed, minimized, eliminated, and/or otherwise substantially reduced, as compared with plasma populations containing a mixture of nuclear materials (e.g., first plasma population 120a).

Alternatively, rather than being formed substantially of tritium, in some embodiments, the second gas population and the third gas population may be formed substantially of deuterium (e.g., second gas population and third gas population formed substantially of deuterium and substantially free of tritium). Accordingly, in some embodiments, the second plasma population 120b and the third plasma population 120c may be formed substantially of a combination of particles and/or ions of deuterium and electrons. In other words, in some embodiments, the second and third plasma populations 120b, 120c may include ions formed substantially of deuterium and/or substantially free of tritium. In such embodiments, the second plasma population 120b and the third population 120c may include only one nuclear material (e.g., deuterium). All such variations are envisioned herein and should be considered as part of the present disclosure.

In some embodiments, the first gas population, the second gas population, and the third gas population may be disposed in the first confinement element 110a, the second confinement element 110b, and the third confinement element 110c, respectively, via the fuel source 130 and heated via the heat source 140 to generate a first ion population and a first electron population disposed in the first confinement element 110a, a second ion population and a second electron population disposed in the second confinement element 110b, and a third ion population and a third electron population disposed in the third confinement element 110c, respectively. In some embodiments, the first ion population, the second ion population, and the third ion population may be formed substantially of deuterium ions, tritium ions, or a combination thereof. In some embodiments, the first ion population, the second ion population, and the third ion population may be generated outside the corresponding confinement element and disposed in the corresponding confinement element thereafter.

In some embodiments, the first plasma population 120a, the second plasma population 120b, and the third plasma population 120c may be distinct from one another, and, therefore, may include distinct ion compositions, ion concentrations, or plasma densities. For example, the first plasma population 120a disposed in the first confinement element 110a need not be the same as the second plasma population 120b in the second confinement element 110b or the third plasma population 120c in the third confinement element 110c. The ion populations of each of the plasma population(s) 120 need not be exchanged, and, hence, an escaping ion having escaped from the first plasma population 120a may escape from the first confinement element 110a and may or may not be retained in the second plasma population 120b or the third plasma population 120c, or vice-versa. In some embodiments, the first plasma population 120a may have a first plasma density, the second plasma population 120b may have a second plasma density, and the third plasma population 120c may have a third plasma density. In some embodiments, the first plasma density may be lower than both the second plasma density and the third plasma density. In some embodiments, the first plasma density may be about equivalent to the second plasma density and/or the third plasma density. In some embodiments, the first plasma density may be greater than the second plasma density and/or the third plasma density.

In some embodiments, each of the distinct plasma population(s) 120 may influence one another via electrostatic and/or diamagnetic interactions. Therefore, although each of the plasma population(s) 120 may be distinct from one another, each may be in electrostatic and/or magnetic communication with one another. In some embodiments, each of the plasma population(s) 120 may be electrostatically and/or magnetically coupled to one another.

In some embodiments, the first confinement element 110a may include the first gas population, the first gas population formed of deuterium, tritium, or a combination thereof. In some embodiments, the first gas population may be ionized (i.e., split to form the ion and the electrons) to form the first plasma population 120a. In some embodiments, the first plasma population 120a may be formed of the first ion population, the first ion population formed of a plurality of deuterium ions, a plurality of tritium ions, or a combination thereof. In some embodiments, the first plasma population 120a may be formed of a combination of deuterium ions and tritium ions. In some embodiments, the deuterium ions and tritium ions may be disposed in the first confinement element 110a via the fuel source 130. The deuterium ions and tritium ions may, for example, be disposed in the first confinement element 110a before or after ionization. The deuterium and tritium may be ionized by any means appropriate, such as via neutral beam injection.

As previously described, the plasma population(s) 120 may each have (i.e., generate, include, produce, etc.) corresponding positive electrostatic potential(s). For example, the first plasma population 120a may have a first electrostatic potential, the second plasma population 120b may have a second electrostatic potential, and the third plasma population 120c may have a third electrostatic potential. In some embodiments, the positive electrostatic potential may balance the ion and electron leakage rates and/or densities. The positive potential developed in one or both the second confinement element 110b and the third confinement elements 110c suppress the axial leakage rate of ions from the first confinement element 110a through each respective and proximate axial end of the first confinement element 110a. In this manner, while the first axial magnetic field at least partially confines the first plasma population 120a in the axial direction via the magnetic mirror effect, any leakage of positively charged ions in the first plasma population 120a along the axial direction, for example, at the axial ends of the first confinement element 110a, is further inhibited by the second and third axial electrostatic potentials. As previously mentioned, this may advantageously increase confinement of ions in the first plasma population 120a in the axial direction, which may consequently increase retention time of the ions and overall efficiency of the fusion reaction occurring within the inner region of the first confinement element 110a.

In some embodiments, the electrostatic potential(s) may vary across an axial and/or radial length of each of the confinement element(s) 110 and/or the plasma population(s) 120. Therefore, each of the confinement element(s) 110 and/or the plasma population(s) 120 may each have corresponding peak electrostatic potential(s) (i.e., maximum electrostatic potential) and average electrostatic potential(s) (e.g., average electrostatic potential across each confinement element(s) 110 and/or plasma population(s) 120). For example, the first plasma population 120a may have a first average electrostatic potential and a first peak electrostatic potential. The second plasma population 120b may have a second average electrostatic potential and a second peak electrostatic potential. The third plasma population 120c may have a third average electrostatic potential and a third peak electrostatic potential.

In some embodiments, the average electrostatic potential(s) of the second plasma population 120b and/or the third plasma population 120c may be greater than the average electrostatic potential of the first plasma population 120a. In other words, the second average electrostatic potential (i.e., of the second plasma population 120b) and/or the third average electrostatic potential (i.e., of the third plasma population 120c) may be greater than the first average electrostatic potential (i.e., of the first plasma population 120a). In some embodiments, both the second average electrostatic potential (i.e., of the second plasma population 120b) and the third average electrostatic potential (i.e., of the third plasma population 120c) may be greater than the first average electrostatic potential (i.e., of the first plasma population 120a). In some embodiments, the average electrostatic potential(s) of the second plasma population 120b and/or the third plasma population 120c may be less than the average electrostatic potential of the first plasma population 120a. In other words, the second average electrostatic potential (i.e., of the second plasma population 120b) and/or the third average electrostatic potential (i.e., of the third plasma population 120c) may be less than the first average electrostatic potential (i.e., of the first plasma population 120a). In some embodiments, the average electrostatic potential(s) of the second plasma population 120b and/or the third plasma population 120c may be substantially equivalent to (i.e., equivalent, substantially the same as, or the same as) the average electrostatic potential of the first plasma population 120a. In other words, the second average electrostatic potential (i.e., of the second plasma population 120b) and the third average electrostatic potential (i.e., of the third plasma population 120c) may each be substantially equivalent to (i.e., equivalent, substantially the same as, or the same as) the first average electrostatic potential (i.e., of the first plasma population 120a).

In some embodiments, the peak electrostatic potential(s) of the second plasma population 120b and/or the third plasma population 120c may be greater than the peak electrostatic potential of the first plasma population 120a. In other words, the second peak electrostatic potential (i.e., of the second plasma population 120b) and/or the third peak electrostatic potential (i.e., of the third plasma population 120c) may be greater than the first peak electrostatic potential (i.e., of the first plasma population 120a. In some embodiments, both the peak electrostatic potentials of the second plasma population 120b and third plasma population 120c may be greater than the peak electrostatic potential of the first plasma population 120a. In some embodiments, the peak electrostatic potential(s) of the second plasma population 120b and/or the third plasma population 120c may be less than the peak electrostatic potential of the first plasma population 120a. In other words, the second peak electrostatic potential (i.e., of the second plasma population 120b) and/or the third peak electrostatic potential (i.e., of the third plasma population 120c) may be less than the first peak electrostatic potential (i.e., of the first plasma population 120a). In some embodiments, the peak electrostatic potential(s) of the second plasma population 120b and/or third plasma population 120c may be substantially equivalent to (i.e., equivalent to, substantially the same as, or the same as) the peak electrostatic potential of the first plasma population 120a. In other words, in some embodiments, the second peak electrostatic potential (i.e., of the second plasma population 120b) and the third peak electrostatic potential (i.e., of the third plasma population 120c) may each be substantially equivalent to (i.e., equivalent to, substantially the same as, or the same as) the first peak electrostatic potential (i.e., of the first plasma population 120a).

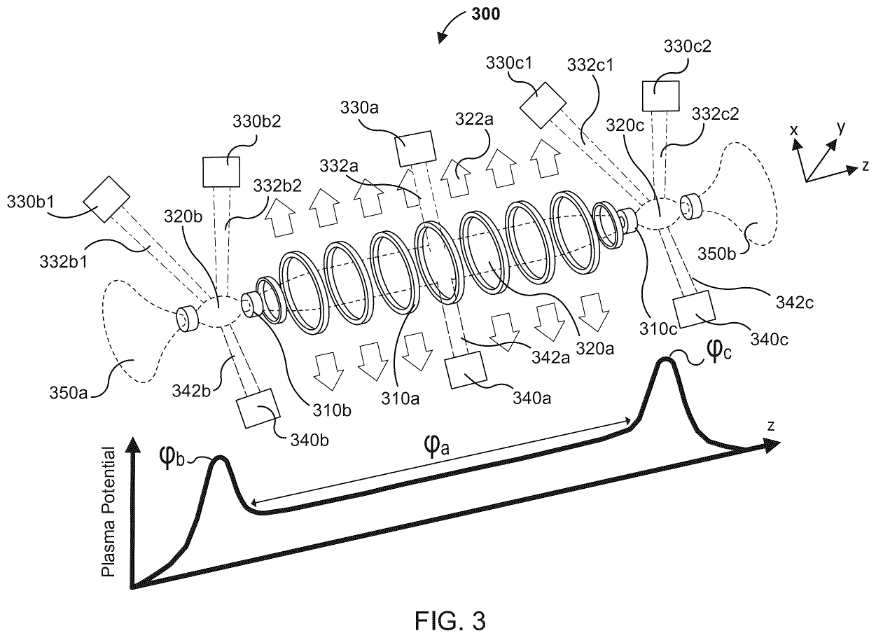

In some embodiments, the second plasma population 120b and the third plasma population 120c may be configured to confine the first plasma population 120a within the first confinement element 110a in the axial direction. For example, in some embodiments, each of the plasma population(s) 120 may include a plasma potential (which may also be referred to as a “electric potential” or an “electrostatic potential”) generated by the corresponding electron population therein. For example, the first plasma population 120a may have a first plasma potential, the second plasma population 120b may have a second plasma potential, and the third plasma population 120c may have a third plasma potential (as described in further detail with respect to FIG. 3). In some embodiments, the first plasma potential may be lower than the second plasma potential and the third plasma potential thereby forming an electrostatic barrier proximate each end of the first confinement element 110a. In some embodiments, the first electrostatic barrier and the second electrostatic barrier may be collectively referred to herein as the “electrostatic barriers” or the “tandem mirror.” In some embodiments, each electrostatic barrier may have an electrostatic confinement force (also referred to herein as “electrostatic force”) having an axial component acting opposite the corresponding end of the first confinement element 110a to at least partially confine the plasma population 120a therein in the axial direction. In other words, the electrostatic confinement forces may have axial components thereof acting toward the center of the first confinement element 110a. For example, the first electrostatic barrier may be disposed proximate the first end of the first confinement element 110a and may have a first electrostatic confinement force acting at least partially towards the second end of the first confinement element 110a. Similarly, the second electrostatic barrier may be disposed proximate the second end of the first confinement element 110a and may have a second electrostatic confinement force acting at least partially towards the first end of the first confinement element 110a.

In some embodiments, each of the second electrostatic potential and the third electrostatic potential may be greater than the first electrostatic potential. For example, an average electrostatic potential of the first, second, and third plasma populations may be greater than an average electrostatic potential of the first plasma population. In some embodiments, the second electrostatic potential and the third electrostatic potential being greater than the first electrostatic potential generates a first electrostatic barrier proximate the first axial end and a second electrostatic barrier proximate the second axial end. In some embodiments, the first electrostatic barrier and the second electrostatic barrier are diametrically opposed. In some embodiments, the first electrostatic barrier and the second electrostatic barrier form the tandem mirror at corresponding axial ends of the inner region to further confine the first plasma population 120a therein in the axial direction.

For example, in some embodiments, the second plasma population 120b may be configured to generate a first electrostatic potential between the second confinement element 110b and the first confinement element 110a. Likewise, in some embodiments, the third plasma population 120c may be configured to generate a second electrostatic potential between the third confinement element 110c and the first confinement element 110a. For example, the second and third plasma populations 120b, 120c may include electrostatically charged ions that are confined via electromagnetic fields at the second and third confinement elements 110b, 110c, thereby generating the second and third electrostatic potentials. The second and third electrostatic potentials serve as electrostatic barriers to axially confine the first plasma population 120a.

In some embodiments, the first electrostatic potential may be disposed proximate the first axial end of the first confinement element 110a and the second electrostatic potential may be disposed proximate the second axial end of the first confinement element 110a. In some embodiments, the first electrostatic potential may create a first electrostatic barrier at the first axial end of the first confinement element 110a, and the second electrostatic potential may create a second electrostatic barrier at the second axial end of the first confinement element 110a. The first electrostatic barrier and the second electrostatic barrier may be collectively referred to as the “electrostatic barriers.” In some embodiments, the electrostatic barriers may generate a confinement force having an axial component in the axial direction away from the axial ends of the first confinement element 110a.

In some embodiments, the second plasma population 120b may be configured to generate the first electrostatic barrier proximate the first axial end of the first confinement element 110a, and the third plasma population 120c may be configured to generate the second electrostatic barrier proximate the second axial end of the first confinement element 210a, the electrostatic barriers configured to form the tandem mirror that at least partially confines the first plasma population 120a in the inner region of the first confinement element 110a. In some embodiments, the tandem mirror may be configured to at least partially confine the first plasma population 120a in the inner region of the first confinement element 110a. In some embodiments, the tandem mirror may be configured to at least partially confine the first plasma population 120a in the inner region of the first confinement element 110a along the axial direction perpendicular to the radial direction. In some embodiments, the second plasma population 120b and the third plasma population 120b may be configured to generate the electrostatic barriers at the corresponding axial ends of the first confinement element 110a, the electrostatic barriers configured to form a tandem mirror therebetween confining the first plasma population 120a in the inner region of the first confinement element 110a. In some embodiments, the tandem mirror is configured to confine the first plasma population 120a in the inner region of the first confinement element 110a along the axial direction perpendicular to the radial direction.

In some embodiments, at least one of the second plasma population 120b and the third plasma population 120c may include a nuclear material having an atomic mass over charge-squared ratio (μ/Z²) in a range of about 1.0 to about 3.5, inclusive of all values and ranges therebetween. For example, in some embodiments, the μ/Z² ratio may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, or about 3.5, inclusive of all values and ranges therebetween. In some embodiments, the p/Z² ratio may be at least about 1.0, at least about 1.1, at least about 1.2, at least about 1.3, at least about 1.4, at least about 1.5, at least about 1.6, at least about 1.7, at least about 1.8, at least about 1.9, at least about 2.0, at least about 2.1, at least about 2.2, at least about 2.3, at least about 2.4, at least about 2.5, at least about 2.6, at least about 2.7, at least about 2.8, at least about 2.9, at least about 3.0, at least about 3.1, at least about 3.2, at least about 3.3, or at least about 3.4. In some embodiments, the p/Z² ratio may be no more than about 3.5, no more than about 3.4, no more than about 3.3, no more than about 3.2, no more than about 3.1, no more than about 3.0, no more than about 2.9, no more than about 2.8, no more than about 2.7, no more than about 2.6, no more than about 2.5, no more than about 2.4, no more than about 2.3, no more than about 2.2, no more than about 2.1, no more than about 2.0, no more than about 1.9, no more than about 1.8, no more than about 1.7, no more than about 1.6, no more than about 1.5, no more than about 1.4, no more than about 1.3, no more than about 1.2, or no more than about 1.1. Combinations of the aforementioned μ/Z² ratios are also possible (e.g., at least about 1.0 and no more than about 3.5, or at least about 2.9 and no more than about 3.1), inclusive of all values and ranges therebetween.

In some embodiments, each of the plasma population(s) 120 may include a plurality of nuclear materials defining a corresponding population of nuclear materials [collectively referred to as “nuclear material population(s)”] such that each of the plasma population(s) 120 [and/or the corresponding nuclear material population(s) thereof] may have a corresponding average atomic mass over charge-squared ratio (μ/Z², may also be designated by μ/Z²ₐᵥₑ and/or referred to as “average μ/Z²”). In some embodiments, the average μ/Z² may be substantially the same as the aforementioned values and ranges as described for μ/Z². In some embodiments, each of the nuclear material population(s) of each of the plasma population(s) 120 may be distinct from one another, such that each of the plasma population(s) 120 has a corresponding and/or distinct mass over charge-squared ratio (μ/Z²). For example, in some embodiments, the first plasma population 120a may have a first average μ/Z² ratio and/or include a first nuclear material population having the first average μ/Z² ratio. In some embodiments, the second plasma population 120b may have a second average μ/Z² ratio and/or include a second nuclear material population having the second average μ/Z² ratio. In some embodiments, the third plasma population 120c may have a third average μ/Z² ratio and/or include a third nuclear material population having the third average μ/Z² ratio.

In some embodiments, the nuclear material(s) of the second plasma population 120b and/or the third plasma population 120c may have an average mass over charge-squared ratio (μ/Z²) greater than the average mass over charge-squared ratio (μ/Z²) of the nuclear material disposed in the first plasma population 120a. In some embodiments, the second average μ/Z² ratio (i.e., of the second plasma population 120b and/or the second nuclear material population) and/or the third average μ/Z² ratio (i.e., of the third plasma population 120c and/or the third nuclear material population) may be greater than the first average μ/Z² ratio (i.e., of the first plasma population 120a and/or the first nuclear material population). In some embodiments, the nuclear material(s) of second plasma population 120b and the third plasma population 120c may have an average mass over charge-squared ratio (μ/Z²) lesser than the average mass over charge-squared ratio (μ/Z²) of the nuclear material included in the first plasma population 120a. In some embodiments, the second average μ/Z² ratio (i.e., of the second plasma population 120b and/or the second nuclear material population) and/or the third average μ/Z² ratio (i.e., of the third plasma population 120c and/or the third nuclear material population) may be less than the first average μ/Z² ratio (i.e., of the first plasma population 120a and/or the first nuclear material population). In some embodiments, the nuclear material(s) of the second plasma population 120b and/or the third plasma population 120c may have an average mass over charge-squared ratio (μ/Z²) substantially equivalent to (i.e., equivalent, substantially the same as, or the same as) the average mass over charge-squared ratio (μ/Z²) of the nuclear material disposed in the first plasma population 120a. In some embodiments, the second average μ/Z² ratio (i.e., of the second plasma population 120b and/or the second nuclear material population) and/or the third average μ/Z² ratio (i.e., of the third plasma population 120c and/or the third nuclear material population) may be substantially the equivalent to (i.e., equivalent, substantially the same as, or the same as) the first average μ/Z² ratio (i.e., of the first plasma population 120a and/or the first nuclear material population).

In some embodiments, the second confinement element 110b and/or the third confinement element 110c may include at least one of tritium gas, tritium particles, and/or tritium ions (and electrons, for example, dissociated electrons formed during ionization of tritium gas and/or particles). For example, the second plasma population 120b or the third plasma population 120c may include tritium ions (and electrons). In some embodiments, the second plasma population 120b or the third plasma population 120c may be formed substantially of tritium ions (and electrons). In some embodiments, the second plasma population 120b or the third plasma population 120c may be formed only of tritium ions (and electrons). In some embodiments, at least one of the end plugs contains only tritium ions (and electrons). In some embodiments, both end plugs contain only tritium ions (and electrons). In other words, as described herein, in some embodiments, the second plasma population 120b and the third plasma population 120c may include only a single nuclear material, such as tritium (e.g., tritium particles and/or ions).

In some embodiments, the second confinement element 110b and/or the third confinement element 110c may include at least one of deuterium gas, deuterium particles, and/or deuterium ions (and electrons). For example, in some embodiments, the second plasma population 120b or the third plasma population 120c may include deuterium ions (and electrons). In some embodiments, the second plasma population 120b or the third plasma population 120c may be formed substantially of deuterium ions (and electrons). In some embodiments, the second plasma population 120b or the third plasma population 120c may be formed only of deuterium ions (and electrons). In some embodiments, at least one of the end plugs include only deuterium ions (and electrons). In some embodiments, both end plugs include only deuterium ions (and electrons). In other words, as described herein, in some embodiments, the second plasma population 120b and the third plasma population 120c may include only a single nuclear material, such as deuterium (e.g., deuterium particles and/or ions).

Although various mass over charge-squared ratios (μ/Z²) are described above, in some embodiments, ions having a high atomic mass over charge-squared ratio (μ/Z²), such as a p/Z² of at least about 2.0 (e.g., deuterium), and/or μ/Z² of at least about 3.0 (e.g., tritium), may be used advantageously in the end plugs. Without being bound by theory, using ions having a μ/Z² of at least about 3.0 in the end plug may help increase the electric potential at the end plugs thereby increasing the electrostatic confinement force acting on the first plasma population 120a in the axial direction. This may, for example, create better axial confinement for the first plasma population 120a in the first confinement element 110a, and, thus, generate higher amounts of energy in the nuclear fusion reactor 100 during the fusion reaction. Tritium, for example, has the highest μ/Z² ratio of any known low-Z ion, and the T-T fusion reaction:

$${}_{1}^{3} T + {}_{1}^{3} T \to {}_{2}^{4} He + 2 n + 11.3 MeV$$

has a reactivity cross-section which is approximately five to ten times lower than the D-D fusion reactions:

$${}_{1}^{2} D + {}_{1}^{2} D \to {}_{1}^{3} T + p + 4.03 MeV \\ {}_{1}^{2} D + {}_{1}^{2} D \to {}_{2}^{3} He + n + 3.27 MeV$$

and an average neutron energy of ˜3 MeV. Thus, a T-only end-plug provides about 20% increase in confinement time and a many-order of magnitude reduction in the neutron rate relative to a D-T end-plug.

In some embodiments, the use of tritium end plugs may advantageously allow for unblanketed end plugs as the tritium plasma forming the end plugs may not contribute meaningfully to fuel consumption within the first confinement element 110a, and simplification of a structure of the second and third confinement elements 110b and 110c as less shielding may be used and thus, smaller bore sizes may be desirable. In some embodiments, use of tritium plasma populations as end plugs may not only have better nuclear properties than other ion compositions, but may also produce higher end plug ion confinement and substantially enhance the overall tandem mirror system's performance.

In some embodiments, the nuclear fusion reactor 100 may include the fuel source 130, or the fuel source 130 may be fluidically coupled to the nuclear fusion reactor 100. The fuel source 130 may be configured to provide fuel to at least one of the plasma population(s) 120. In some embodiments, the fuel source 130 may be configured to fuel at least one of the plasma population(s) 120a, 120b, 120c via Neutral Beam Injection (NBI), gas puffing (i.e., insertion of puffs of neutral deuterium or tritium gas), pellet injection (i.e., injection of a frozen gas of tritium, deuterium, or a combination thereof), or any suitable combination thereof. In some embodiments, the fuel source 130 may be a neutral beam generator (also referred to herein as “neutral beam source” and/or “neutral beam injector”) configured to direct a beam of neutral particles (also referred to as a “neutral beam”) into at least one of the first confinement element 110a, the second confinement element 110b, or the third confinement element 110c to generate the first plasma population 120a, the second plasma population 120b, or the third plasma population 120c, respectively.

In some embodiments, the neutral beam of neutral particles, i.e., the neutral beam, may disassociate into ions and electrons thereby fueling the corresponding plasma population. In some embodiments, the fuel source 130 may include any suitable source of gas (e.g., deuterium gas and/or tritium gas). In some embodiments, the fuel source 130 (e.g., source of gas) may be fluidically, thermally, and/or otherwise operably coupled to the confinement element(s) 110 and configured to communicate the gas to the inner region(s) of the confinement element(s) 110, for example, to facilitate initiation and/or fueling of the plasma population(s) 120 therein. For example, in some embodiments, the fuel source 130 may include a cylinder, container, and/or canister configured to contain the gas (e.g., including deuterium and/or tritium). In some embodiments, the fuel source 130 may include tubing and/or conduits fluidically coupled to the inner region(s) and/or configured to communicate the gas to the inner region(s).

In some embodiments, the source of gas may include a gas generator configured to generate a neutral gas and fuel via gas puffing at least one of the first confinement element 110a, the second confinement element 110b, and/or the third confinement element 110c to fuel the first plasma population 120a, the second plasma population 120b, or the third plasma population 120c, respectively. In some embodiments, the source of gas may include a gas cylinder, a reactor, or any other source that generates the gas, for example, at a desired flow rate, pressure, etc. In some embodiments, the fuel source 130 may include a pellet generator configured to generate a pellet to fuel at least one of the first plasma population 120a, the second plasma population 120b, and/or the third plasma population 120c via pellet injection. The pellet may be formed of frozen deuterium, tritium, or any suitable combination thereof. In some embodiments, the fuel source 130 may include a neutral beam generator, a gas generator, a pellet generator, or any suitable combination thereof. In some embodiments, the nuclear fusion reactor 100 may include a single fuel source 130, which may be configured to fuel each of the distinct plasma population(s) 120. However, in some embodiments, the nuclear fusion reactor 100 may include a plurality of fuel sources.

Various examples of the fuel source 130 may be found in PCT Application No. PCT/US2021/022554, filed Mar. 16, 2021, and entitled “High-energy plasma generator using radio-frequency and neutral beam power,” the entire disclosure of which is incorporated herein by reference.

In some embodiments, the nuclear fusion reactor 100 includes the heat source 140 as shown in FIG. 1. The heat source 140 may be configured to heat at least one of the plasma population(s) 120a, 120b, or 120c. In some embodiments, the heat source 140 may be configured to heat at least one of the first ion population disposed within the first confinement element 110a, the second ion population disposed within the second confinement element 110b, or the third ion population disposed within the third confinement element to establish at least one of the first plasma population 120a, the second plasma population 120b, or the third plasma population 120c, respectively. In some embodiments, at least one of the energy source 130 and/or the heat source 140 may be configured to heat one or more of the plasma population(s) 120 to form one or more thermal plasmas, respectively, for example, having a Maxwellian particle energy distribution. For example, in some embodiments, at least one of the energy source 130 and/or the heat source 140 may be configured to heat one or more of the plasma population(s) 120 to a Maxwellian particle energy distribution.

In some embodiments, the heat source 140 may be configured to heat at least one of the first plasma population 120a, the second plasma population 120b, and the third plasma population 120c to a predetermined temperature (T). In some embodiments, the predetermined temperature may be sufficient to promote a fusion reaction of ions therein. Hence, in some embodiments, the predetermined temperature may be referred to herein as “fusion temperature.” In some embodiments, the heat source 140 may be configured to heat the ions in one or more of the plasma population(s) 120 to an ion temperature (Tᵢ). In some embodiments, the heat source 140 may be configured to heat the electrons in one or more of the plasma population(s) 120 to an electron temperature (τₑ). In some embodiments, the ion temperature (Tᵢ) is sufficient to promote fusion. Any suitable heat source 140 may be used, for example, an NBI, an electron cyclotron source (also referred to as “electron cyclotron generator” and/or “electron cyclotron heater”), or a combination thereof.

In some embodiments, the fusion temperature, and/or the ion temperature Tᵢ, achievable in the inner region(s) of the confinement element(s) 110, for example, in the plasma population(s) 120, may be at least about 10,000,000 degrees Celsius (C) or higher. In some embodiments, the predetermined temperature T and/or ion temperature Tᵢ may be in a range of about 10,000,000° C. to about 12,000,000,000° C., inclusive of all values and ranges therebetween.

For example, in some embodiments, the predetermined temperature T and/or ion temperature Tᵢ may be at least about 10,000,000° C., at least about 20,000,000° C., at least about 30,000,000° C., at least about 40,000,000° C., at least about 50,000,000° C., at least about 60,000,000° C., at least about 70,000,000° C., at least about 80,000,000° C., at least about 90,000,000° C., at least about 100,000,000° C., at least about 150,000,000° C., at least about 200,000,000° C., at least about 300,000,000° C., at least about 400,000,000° C., at least about 500,000,000° C., at least about 600,000,000° C., at least about 700,000,000° C., at least about 800,000,000° C., at least about 900,000,000° C., at least about 1,000,000,000° C., at least about 2,000,000,000° C., at least about 3,000,000,000° C., at least about 4,000,000,000° C., at least about 5,000,000,000° C., at least about 6,000,000,000° C., at least about 7,000,000,000° C., at least about 8,000,000,000° C., at least about 9,000,000,000° C., at least about 10,000,000,000° C., or at least about 11,000,000,000° C.

In some embodiments, the predetermined temperature T and/or ion temperature Tᵢ may be no more than about 12,000,000,000° C., no more than about 11,000,000,000° C., no more than about 10,000,000,000° C., no more than about 9,000,000,000° C., no more than about 8,000,000,000° C., no more than about 7,000,000,000° C., no more than about 6,000,000,000° C., no more than about 5,000,000,000° C., no more than about 4,000,000,000° C., no more than about 3,000,000,000° C., no more than about 2,000,000,000° C., no more than about 1,000,000,000° C., no more than about 900,000,000° C., no more than about 800,000,000° C., no more than about 700,000,000° C., no more than about 600,000,000° C., no more than about 500,000,000° C., no more than about 400,000,000° C., no more than about 300,000,000° C., about 200,000,000° C., no more than about 150,000,000° C., no more than about 100,000,000° C., no more than about 90,000,000° C., no more than about 80,000,000° C., no more than about 70,000,000° C., no more than about 60,000,000° C., no more than about 50,000,000° C., no more than about 40,000,000° C., no more than about 30,000,000° C., or no more than about 20,000,000° C.

Combinations of the above-referenced predetermined temperatures T and/or ion temperatures Tᵢ are also possible (e.g., at least about 10,000,000° C. and no more than about 12,000,000,000° C., or at least about 50,000,000° C. and no more than about 10,000,000,000° C.), inclusive of all values and ranges therebetween.

In some embodiments, the electron temperature (Tₑ) may be about equal to or substantially equal to the ion temperature (Tᵢ). In some embodiments, the electron temperature (Tₑ) may be less than the ion temperature, or, in some embodiments, the electron temperature (Tₑ) may be greater than the ion temperature (Tᵢ). In some embodiments, the electron temperature Tₑ may be in a range of about 1% to about 200% relative to the ion temperature Tᵢ, inclusive of all values and ranges therebetween. In other words, in some embodiments, a ratio of electron temperature Tₑ to ion temperature Tᵢ may be in a range of about 0.01≤Tₑ/Tᵢ≤about 2.0, inclusive of all values and ranges therebetween. For example, in some embodiments, the Tₑ/Tᵢ ratio may be about 0.01, about 0.05, about 0.10, about 0.20, about 0.30, about 0.40, about 0.50, about 0.60, about 0.70, about 0.80, about 0.90, about 1.00, about 1.10, about 1.20, about 1.30, about 1.40, about 1.50, about 1.60, about 1.70, about 1.80, about 1.90, about 2.00, inclusive of all values and ranges therebetween. In some embodiments, the Tₑ/Tᵢ ratio may be at least about 0.01, at least about 0.05, at least about 0.10, at least about 0.20, at least about 0.30, at least about 0.40, at least about 0.50, at least about 0.60, at least about 0.70, at least about 0.80, at least about 0.90, at least about 1.00, at least about 1.10, at least about 1.20, at least about 1.30, at least about 1.40, at least about 1.50, at least about 1.60, at least about 1.70, at least about 1.80, or at least about 1.90. In some embodiments, the Tₑ/Tᵢ ratio may be no more than about 2.00, no more than about 1.90, no more than about 1.80, no more than about 1.70, no more than about 1.60, no more than about 1.50, no more than about 1.40, no more than about 1.30, no more than about 1.20, no more than about 1.10, no more than about 1.00, no more than about 0.90, no more than about 0.80, no more than about 0.70, no more than about 0.60, no more than about 0.50, no more than about 0.40, no more than about 0.30, no more than about 0.20, no more than about 0.10, or no more than about 0.05. Combinations of the aforementioned Tₑ/Tᵢ ratios are also possible (e.g., at least about 0.01 and no more than about 2.0, or at least about 0.05 and no more than about 1.0), inclusive of all values and ranges therebetween.

In some embodiments, one or more of the plasma population(s) 120 may be heated to a non-thermal distribution (i.e., plasma with non-Maxwellian particle energy distributions), which may be characterized by median or mean ion energy Ei (also referred to herein as “ion energy”). For example, in some embodiments, the fuel source 130 and/or the heat source 140 may be configured to energize the ions in the one or more plasma population(s) 120 to an ion energy sufficient to promote fusion. In some embodiments, to promote fusion of the ions within one or more of the confinement element(s) 110 (e.g., in the corresponding inner region(s)), the ion energy may be in a range of about 100 kiloelectronvolts (keV) to about 1 megaelectronvolt (MeV), inclusive of all values and ranges therebetween. For example, in some embodiments, the ion energy may be about 100 keV, about 150 keV, about 200 keV, about 250 keV, about 300 keV, about 350 keV, about 400 keV, about 450 keV, about 500 keV, about 550 keV, about 600 keV, about 650 keV, about 700 keV, about 750 keV, about 800 keV, about 850 keV, about 900 keV, about 950 keV, or about 1000 keV (i.e., 1 MeV), inclusive of all values and ranges therebetween. In some embodiments, the ion energy may be at least about 100 keV, at least about 150 keV, at least about 200 keV, at least about 250 keV, at least about 300 keV, at least about 350 keV, at least about 400 keV, at least about 450 keV, at least about 500 keV, at least about 550 keV, at least about 600 keV, at least about 650 keV, at least about 700 keV, at least about 750 keV, at least about 800 keV, at least about 850 keV, at least about 900 keV, or at least about 950 keV. In some embodiments, the ion energy may be no more than about 1 MeV, no more than about 950 keV, no more than about 900 keV, no more than about 850 keV, no more than about 800 keV, no more than about 750 keV, no more than about 700 keV, no more than about 650 keV, no more than about 600 keV, no more than about 550 keV, no more than about 500 keV, no more than about 450 keV, no more than about 400 keV, no more than about 350 keV, no more than about 300 keV, no more than about 250 keV, no more than about 200 keV, or no more than about 150 keV. Combinations of the aforementioned ion energies are also possible (e.g., at least about 100 keV and no more than about 1 MeV, or at least about 400 keV and no more than about 950 keV), inclusive of all values and ranges therebetween.

In some embodiments, the nuclear fusion reactor 100 may include a first expander 150a or a second expander 150b disposed proximate and axially outwards of the second confinement element 110b or the third confinement element 110c, respectively. In some embodiments, the first expander 150a and the second expander 150b (collectively referred to herein as “expanders 150”) may be configured to stabilize one of the plasma populations 120 and/or direct axially escaping ion(s) to an optional direct energy conversion system (not shown). In some embodiments, the expanders 150 may be configured to allow one or more ions escaping from second confinement element 110b or the third confinement element 110c to expand or lose energy in a controlled fashion. In some embodiments, each expander, 150a and 150b, may include corresponding confinement element(s) to create corresponding magnetic field(s) therein configured to confine and stabilize any plasma ions having escaped axially from the first confinement element 110a, the second confinement element 110b, and/or the third confinement element 110c. This may, for example, help to stabilize the plasma populations, 120a, 120b, or 120c, in the reactor 100.

In some embodiments, the reactor 100 may include a divertor (not shown) configured to capture low-energy plasma ions within any of the confinement elements 110a, 110b, or 110c, and discharge the low-energy plasma ions outside of the corresponding confinement element. The divertor may have a distinct volume outside of a plasma containment volume (may also be referred to as a confinement volume or the inner region) for capturing and discharging low-energy ions. In some embodiments, the divertor may use magnetic coils that locally divert the magnetic flux lines within at least one of the confinement elements, 110a, 110b, or 110c, into a distinct divertor volume, producing an exit channel for low-energy plasma ions spiraling near the periphery of the containment volume.

Without being bound by any particular theory, in some embodiments, the divertor may create an X point of zero magnetic field allowing plasma ions at the periphery of the containment volume to escape into the extraction volume outside of the containment volume. After passing through the exit channel, the captured ions may collide with a divertor target in an extraction volume distinct from the corresponding confinement element. There, the ions may be neutralized and may be pumped away by appropriate vacuum pumps. As well as managing for the removal of low-energy ions, the divertor may also improve the stability of the plasma (i.e., a magnetohydrodynamic stability), possibly by locally weakening the axial magnetic field of one of the confinement elements, 110a, 110b, or 110c, to produce a circular channel along which electrons can flow to eliminate destabilizing azimuthal electrical field gradients. The divertor may be disposed proximate, within, partially within, or incorporated into one of the confinement elements 110a, 110b, or 110c. The divertor magnet may include rare-earth permanent magnet materials such as a neodymium magnet (NdFEB), samarium cobalt (SmCo), or iron nitride (FeN).

Various examples of divertors that may be used in the systems, apparatuses, and methods described herein may be found in PCT Application No. PCT/US2022/039709, filed Aug. 8, 2022, and entitled “High-energy plasma generator with permanent magnet divertor,” the entire disclosure of which is incorporated herein by reference.

In some embodiments, the reactor 100 may include a direct energy convertor disposed axially at one end or both ends of the reactor 100, such as axially flanking the outer end of the second confinement element 110b, the third confinement element 110c, the first expander 150a, or the second expander 150b. In some embodiments, the direct energy convertor may also use a magnetic electron separator configured to separate electrons out of the plasma, and a plate getter material configured to receive the separated electrons and convert them to usable electrical energy. In some embodiments, the direct energy converter may be axially positioned along an axis of the reactor 100 outside of the magnetic mirror confinement field may include multiple arrays of radially spaced apart charged plates separated by gaps aligned with trajectories of ions escaping from the magnetic mirror confinement field to generate electrical power therefrom.

Various examples of direct energy convertors that may be used in the systems, apparatuses, and methods described herein may be found in PCT Application No. PCT/US2023/011606, filed Jan. 26, 2023, and entitled “Direct energy converter for axisymmetric mirror fusion reactor,” the entire disclosure of which is incorporated herein by reference.

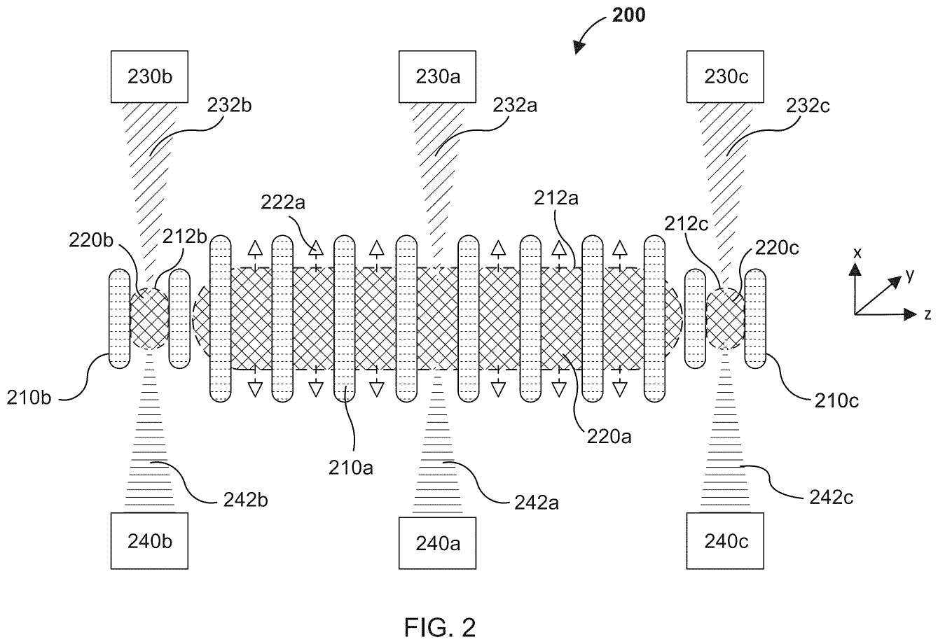

FIG. 2 is a schematic illustration of the nuclear fusion reactor 200, according to an embodiment. The nuclear fusion reactor 200 (also referred to herein as “reactor 200”) includes a first confinement element 210, a second confinement element 210b disposed axially outward of a first axial end of the first confinement element 210a, and a third confinement element 210c disposed axially outward of a second axial end of the first confinement element 210a opposite the first axial end. The first, second, and third confinement elements 210a, 210b, 210c (collectively referred to herein as “confinement element(s) 210”) are configured to confine or contain a first plasma population 220a, a second plasma population 220b, and a third plasma population 220c (collectively referred to herein as “plasma population(s) 220), respectively. The first, second, and third confinement elements 210a, 210b, and 210c, and the first, second, and third plasma populations 220a, 220b, and 220c may be substantially similar to the first, second, and third confinement elements 110a, 110b, and 110c, and the first, second, and third plasma populations 120a, 120b, and 120c as described with respect to FIG. 1, respectively. Therefore, certain features of the confinement element(s) 210 and/or the plasma population(s) 220 are not described in further detail herein.

The first confinement element 210a at least partially defines a first inner region 212a configured to contain or confine the first plasma population 220a, the second confinement element 210b defines a second inner region 212b configured to contain or confine the second plasma population 220b, and the third confinement element 210c may define a third inner region 212c configured to contain or confine the third plasma population 220c. In some embodiments, the first confinement element 210a may include a series of electromagnetic coils extending in an axial direction to define the first inner region 212a. The first confinement element 210a is configured to confine the first plasma population 220a in a radial direction via an axial magnetic field and at least partially in the axial direction via a magnetic mirror effect at each axial end. Moreover, each of the second and third confinement elements 210b and 210c may include a pair of electromagnetic coils, or even more electromagnetic coils, configured to confine the second and third plasma populations 220b and 220c therewithin or therebetween, respectively. The second and third plasma populations 220b and 220c may be electrostatically and/or electromagnetically charged and serve as axial barriers to axially confine the first plasma population 220a within the first inner region 212a, for example, by inhibiting leakage or escape of the first plasma population 220a through the first and second axial end of the first inner region 212a, for example, by “reflecting” the first plasma population 220a into the first inner region 212a. In this manner, the second and third plasma populations 220b and 220c serve as tandem mirrors, as previously described. The first, second, and third confinement elements 210a, 210b, 210c may be substantially similar to the first, second, and third confinement elements 110a, 110b, 110c, respectively, and, therefore, certain features of these elements are not described in further detail herein.

As shown in FIG. 2, in the tandem mirror configuration, the first plasma population 220a may have a plasma flux 222a oriented at least partially in an outwards radial direction. In some embodiments, a first fuel source 230a may be configured to fuel the first plasma population 220a via a first fuel path 232a, a second fuel source 230b may be configured to fuel the second plasma population 220b via a second fuel path 232b, and a third fuel source 230c may be configured to fuel the third plasma population 220c via a third fuel path 232c. In some embodiments the first, second, and third fuel sources 230a, 230b, 230c may be collectively referred to herein as “fuel source(s) 230.” In some embodiments the first, second, and third fuel paths 232a, 232b, 232c may be collectively referred to herein as “fuel path(s) 232”). Moreover, a first heat source 240a may be configured to heat the first plasma population 220a via a first heat path 242a, a second heat source 240b may be configured to heat the second plasma population 220b via a second heat path 242b, and a third heat source 240c may be configured to heat the third plasma population 220c via the third heat path 242c, according to an embodiment. The first, second, and third heat sources 240a, 240b, 240c may be collectively referred to herein as “heat source(s) 240.” Moreover, the first, second, and third heat paths 242a, 242b, 242c may be collectively referred to herein as “heat paths 242.” The first, second, and third plasma populations 220a, 220b, 220c may be substantially similar to the first, second, and third plasma populations 120a, 120b, and 120c, respectively, and, therefore, certain features of these elements are not described in further detail herein.

In some embodiments, the fuel source(s) 230 may each be configured to direct corresponding fuels to the inner region(s) via corresponding fuel path(s) 232. For example, in some embodiments, a first fuel may be communicated to the first plasma population 220a, a second fuel may be communicated to the second plasma population 220b, and a third fuel may be communicated to the third plasma population 220c, for example, via corresponding fuel source(s) 230 and/or fuel path(s) 232. In some embodiments, the fuels may be similar to or substantially the same as the fuels described with respect to FIG. 1. In some embodiments, the first fuel may be similar to or substantially the same as the second fuel and/or the third fuel. However, in some embodiments, the first fuel may be different from the second fuel and/or the third fuel. For example, in some embodiments, the first fuel may include deuterium and/or tritium (e.g., gases and/or neutral particles thereof), such as a combination of deuterium and tritium. In contrast, in some embodiments, the second fuel and the third fuel may be formed substantially of one of deuterium or tritium, and may be substantially free of the other of deuterium or tritium (e.g., include a de minimis amount of the other ion). In other words, in some embodiments, the second and third fuels may be formed substantially of deuterium and/or may be substantially free of tritium. Alternatively, in some embodiments, the second and third fuels may be formed substantially of tritium and/or may be substantially free of deuterium. All such variations are envisioned herein and should be considered as part of the present disclosure.

In some embodiments, each of the first inner region 212a, the second inner region 212b, and the third inner region 212c (collectively referred to herein as “inner region(s) 212”) may be defined by magnetic fields created by the corresponding confinement elements 210a, 210b, and 210c, as previously described with respect to FIG. 1.

In some embodiments, the plasma flux 222a is in the outwards radial direction perpendicular to the axial direction. However, in some embodiments, the plasma flux 222a may have a radial component and an axial component. In some embodiments, each of the plasma population(s) 220a, 220b, 220c has a corresponding plasma flux (not shown), each of the plasma fluxes having a radial component, an axial component, or any suitable combination thereof.

In some embodiments, the first fuel source 230a may be a first neutral beam generator configured to direct a first neutral beam into the first confinement element 210a to fuel the first plasma population 220a within the first confinement element 210a thereby fueling the first plasma population 220a. In some embodiments, the second fuel source 230b may be a second neutral beam generator configured to direct a second neutral beam into the second confinement element 210b to fuel the second plasma population 220b. In some embodiments, the third fuel source 230c may be a third neutral beam generator configured to direct a third neutral beam into the third confinement element 210c to fuel the third plasma population 220c. In some embodiments, the first fuel path 232a may be the first neutral beam, the second fuel path 232b may be the second neutral beam, or the third fuel path 232c may be the third neutral beam.

However, in some embodiments, the first fuel source 230a, the second fuel source 230b, and/or the third fuel source 230c may include a source of gas. For example, in some embodiments, one or more of the fuel source(s) 230 may include a canister and/or cylinder containing a gas (e.g., including deuterium and/or tritium). In some embodiments, the gas canister may be configured to communicate the gas into the corresponding inner region(s) 212, for example, to facilitate initiation and/or fueling of the plasma population(s) 220 therein. In some embodiments, the fuel source(s) 230 (e.g., gas canisters) may be fluidically coupled to the inner region(s) 212, for example, via tubing and/or conduits.

In some embodiments, the fuel source(s) 230 may include, for example, a gas cylinder, a gas generator, a pellet generator, or any other gas source, configured to fuel at least one of the corresponding plasma populations via gas puffing or pellet injection, respectively. In some embodiments, the first fuel source 230a may be a pellet generator configured to fuel the first plasma source 230a inside the first confinement element 210a via pellet injection of pellets. In some embodiments, the pellets may include a frozen fuel source, for example, frozen deuterium, tritium, or a combination thereof. In some embodiments, the first fuel path 232a, the second fuel path 232b, and/or the third fuel path 232c may include tubing or conduits configured to introduce the neutral gas or the pellets to the first plasma population 220a, the second plasma population 220b, or the third plasma population 220c. In some embodiments, the first plasma population 220a may be fueled via gas puffing or pellet injection while the second plasma population 220b and the third plasma population 220c may be fueled via neutral beam injection. For example, in some embodiments, the second fuel source 230b and the third fuel source 230c may be the first neutral beam generator and the second neutral beam generator, respectively. The first neutral beam generator and the second neutral beam generator may be collectively referred to herein as the “end plug neutral beam generators.”

For example, as shown in FIG. 2, the nuclear fusion reactor 200 may include a first heat source 240a, a second heat source 240b, and a third heat source 240c (collectively referred to as “heat source(s) 240”). The first heat source 240a may be configured to heat the first plasma population 220a disposed within the first confinement element 210a via a first heat path 242a, the second heat source 240b may be configured to heat the second plasma population 220b within the second confinement element 210b via a second heat path 242b, and the third heat source 240c may be configured to heat the third plasma population 220c within the third confinement element 210c via a third heat path 242c. In some embodiments, the heat paths 242a, 242b, 242c may be collectively referred to as “heat path(s) 242.” In some embodiments, the first heat source 240a may be configured to heat the first gas population or the first ion population to generate the first plasma population 220a, the second heat source 240b may be configured to heat the second gas population or the second ion population to generate the second plasma population 220b, and the third heat source 240c may be configured to heat the third gas population or the third ion population to generate the third plasma population 220c. In some embodiments, the fusion reactor 200 may include a single heat source 240 corresponding to each confinement element 210a, 210b, 210c or each plasma population 220a, 220b, 220c, i.e., the first heat source 240a, the second heat source 240b, and the third heat source 240c. In some embodiments, the reactor 200 may include a plurality of heat source(s) 240 configured to heat at least one of the plasma population(s) 220. For example, any of the first plasma population 220a, the second plasma population 220b, or the third plasma population 220c may be heated via a plurality of heat sources 240, each of the plurality of heat sources 240 having corresponding heat path(s) 242 directing heat to the corresponding plasma population(s) 220.

In some embodiments, the heat source 140 and/or the heat source(s) 240 may be configured to communicate energy, such as electromagnetic energy, into the inner region(s) 212, and the energy may be configured to heat the plasma population(s) 220. In some embodiments, the heat source 140, or the heat source(s) 240, may be configured to heat at least one of the plasma population(s) 220 via electron cyclotron heating (ECH) [e.g., electron cyclotron resonance heating (ECRH) or electron cyclotron current drive (ECCD)], ion cyclotron heating (ICH) [e.g., ion cyclotron resonance heating (ICRH) or ion cyclotron current drive (ICCD)], neutral beam injection (NBI), radio frequency (RF) heating, radio frequency current drive (RFCD), ion cyclotron radio frequency (ICRF), or any suitable combination thereof. Accordingly, in some embodiments, the heat source 140 and/or the heat source(s) 240 may be configured to generate and/or communicate particles, beams (e.g., neutral beams), and/or waves (e.g., RF waves, electron cyclotron waves, etc.) of energy to the inner volume(s) 212 to heat the plasma population(s) 220. For example, in some embodiments, at least one of the first heat source 240a, the second heat source 240b, or the third heat source 240c may be an electron cyclotron generator configured to heat the first plasma population 220a, the second plasma population 220b, or the third plasma population 220c via electron cyclotron heating via the first heat path 242a, the second heat path 242b, or the third heat path 242c, respectively. In some embodiments, at least one of the first plasma population 220a, the second plasma population 220b, or the third plasma population 220c may be simultaneously fueled and heated via a combination of neutral beam injection and electron cyclotron heating. All such variations are envisioned herein and should be considered as part of the present disclosure.

As previously described with respect to FIG. 1, each of the plasma population(s) 220 may contain ions (i.e., positively charged ions) and electrons (i.e., negatively charged electrons). In some embodiments, the leakage rate of the electrons exceeds the leakage rate of ions from one or more of the plasma population(s) 220. In this case, the corresponding confinement element(s) 210 may have an associated positive electrostatic potential determined by the relative ratio of positively charged ions to negatively charged electrons. In other words, the plasma population(s) 220 may each have (i.e., generate, include, produce, etc.) corresponding positive electrostatic potential(s). For example, the first plasma population 220a may have a first electrostatic potential, the second plasma population 220b may have a second electrostatic potential, and the third plasma population 220c may have a third electrostatic potential.

In some embodiments, the positive electrostatic potential may balance the ion and electron leakage rates and/or densities. The positive potential developed in one or both the second confinement element 210b and the third confinement elements 210c suppress the axial leakage rate of ions from the first confinement element 210a through each respective and proximate axial end of the first confinement element 210a. In this manner, while the first axial magnetic field at least partially confines the first plasma population 220a in the axial direction via the magnetic mirror effect, any leakage of positively charged ions in the first plasma population 220a along the axial direction, for example, at the axial ends of the first confinement element 210a, may be further inhibited by the second and third axial electrostatic potentials. As previously mentioned, this may advantageously increase confinement of ions in the first plasma population 220a in the axial direction, which may consequently increase retention time of the ions and overall efficiency of the fusion reaction occurring within first confinement element 210a.

In some embodiments, each of the heat source(s) 240 may be configured to heat corresponding plasma population(s) 220 and/or generate electrostatic potentials within the corresponding plasma population(s) 220. For example, in some embodiments, the first heat source 240a may be configured to heat the first plasma population 220a to generate the first electrostatic potential. In some embodiments, the second heat source 240b may be configured to heat the second plasma population 220b to generate the second electrostatic potential. Likewise, in some embodiments, the third heat source 240c may be configured to heat the third plasma population 220c to generate the third electrostatic potential. In some embodiments, the second electrostatic potential and the third electrostatic potential may be greater than the first electrostatic potential. In such cases, the electrostatic potentials of the second plasma population 220b and/or the third plasma population 220c may further confine the first plasma population 220a (i.e., or ions in the first plasma population 220a) within the first confinement element 210a and/or the first inner region 212a in the axial direction. In some embodiments, the second electrostatic potential (i.e., from the second plasma population 220b) may form a first electrostatic barrier proximate the first axial end of the first confinement element 210a.

In some embodiments, the second electrostatic potential (i.e., of the second plasma population 220b) may form a second electrostatic barrier proximate the second axial end of the first confinement element 210a. In some embodiments, the first electrostatic barrier and the second electrostatic barrier in combination, i.e., the “electrostatic barriers,” may be configured to form a tandem mirror. In other words, the electrostatic barriers may form an electrostatic barrier pair configured to reflect any ion in the first plasma population 220a travelling axially from the first inner region 212a. In such a manner, the electrostatic barriers may at least partially confine the first plasma population 220a within the first confinement element 210a. In some embodiments, the tandem mirror may be configured to at least partially confine the first plasma population 220a in the first inner region 212a of the first confinement element 210a. In some embodiments, the tandem mirror may be configured to at least partially confine the first plasma population 220a in the first inner region 212a of the first confinement element 210a along an axial direction perpendicular to the radial direction.

In some embodiments, there may be a plurality of fuel sources 230 directing a plurality of fuel paths 232 into the one or more of the confinement element(s) 210. For example, FIG. 3 shows an illustration of a nuclear fusion reactor 300 (also referred to herein as “reactor 300”) and an associated plasma potential at various axial locations of the reactor 300, according to an embodiment. The reactor 300 includes a first confinement element 310a at least partially defining an inner region and configured to confine a first plasma population 320a in the first inner region. The reactor 300 also includes second and third confinement elements 310b and 310c that at least partially define second and third inner regions, respectively configured to confine second and third plasma populations 320b and 320c, respectively. The first, second and third confinement elements 310a, 310b, 310c, and the first, second, and third plasma populations 320a, 320b, and 320c, may be substantially similar to the first, second, and third confinement elements 210a, 210b, 210c, and the first, second, and third plasma populations, 220a, 220b, 220c, respectively, and, therefore, certain features thereof are not described in further detail herein.

As shown in FIG. 3, a first fuel source 330a may be configured to fuel the first plasma population 320a via a first fuel path 332a, a second fuel source 330b1 may be configured to at least partially fuel the second plasma population 320b via a second fuel path 332b1, a third fuel source 330b2 may be configured to at least partially fuel the second plasma population 320b via a third fuel path 332b2, a fourth fuel source 330cl may be configured to fuel the third plasma population 320c via a fourth fuel path 332cl, and a fifth fuel source 330c2 may be configured to at least partially fuel the third plasma population 320c via a fifth fuel path 332c2. In some embodiments, each plasma population may be fueled by two or more fuel sources and associated fuel paths, each of which may be the same or different. In some embodiments, at least one of the first fuel source 330a, the second fuel source 330b1, the third fuel source 330b2, the fourth fuel source 330cl, or the fifth fuel source 330c2 may be the neutral beam generator configured to direct a neutral beam of neutral particles via neutral beam injection (NBI) into at least one of the first confinement element 310a, the second confinement element 310b, or the third confinement element 310c to fuel the first plasma population 320a, the second plasma population 320b, or the third plasma population 320c, respectively. In some embodiments, at least one of the first fuel path 332a, the second fuel path 332b1, the third fuel path 332b2, the fourth fuel path 332c1, and the fifth fuel path 332c2 may be one or more neutral beams. In some embodiments, the neutral particles may disassociate into ions and electrons within each respective confinement element to form the corresponding plasma populations. In some embodiments, there may be a plurality of neutral beam generators directing neutral beams into the same confinement element or different confinement elements.

The reactor 300 may include a plurality of heat sources. For example, as shown in FIG. 3, the reactor 300 includes a first heat source 340a configured to heat the first plasma population 320a via a first heat path 342a, a second heat source 340b configured to heat the second plasma population 320b via a second heat path 342b, and a third heat source 340c configured to heat the third plasma population 320c via a third heat path 342c. The reactor 300 may optionally, also include a first expander 350a disposed axially outward of the second confinement element 310ba, and a second expander 350b disposed axially outward of the third confinement element 310c. The first, second, and third heat sources 340a, 340b, 340c, and the first and second expanders 350a, 350b may be substantially similar to the heat source 140, the first expander 150a, and the second expander 150b, respectively, and, therefore, certain features thereof are not described in further detail herein.

FIG. 3 also shows a plot of plasma potentials along various axial locations z of the reactor 300. As shown, the first plasma population 320a has a plasma flux 322a and a first plasma potential Pa having a first magnitude. The second plasma population 320b has a second plasma potential Ob having a second amplitude, and the third plasma population 320c has a third plasma potential qc having a third amplitude that may be substantially similar to the second amplitude. The first amplitude of the first plasma potential Pa is smaller than the second amplitude of the second plasma potential Ob and the third amplitude of the third plasma potential Qc, thus enabling the second and third plasma populations 320b and 320c to axially confine the first plasma population 320a. In some embodiments, each of the plasma populations may have distinct plasma fluxes as previously described with respect to FIG. 1 or FIG. 2.

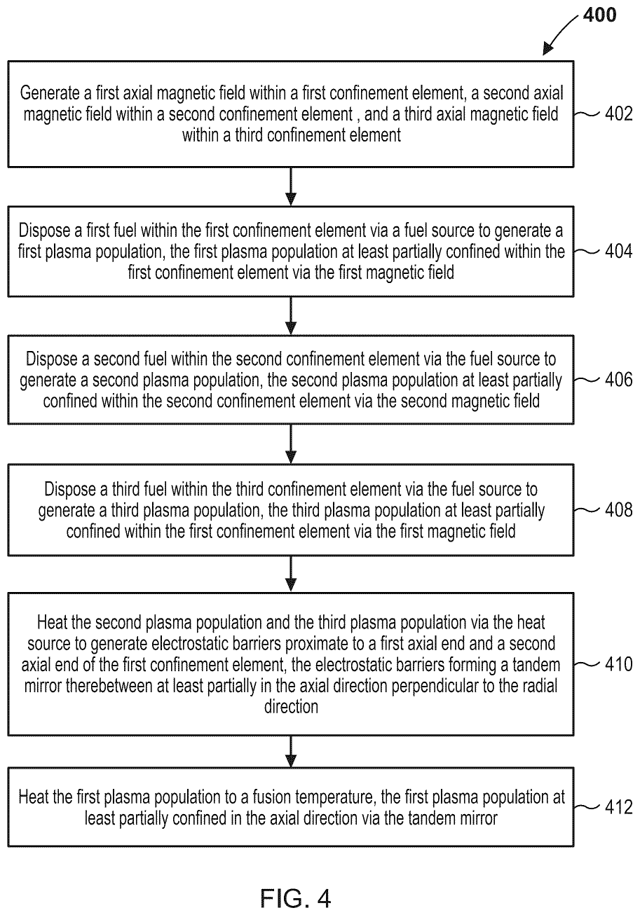

FIG. 4 is a schematic flow chart of a method 400 for producing nuclear fusion in a nuclear fusion reactor, for example, the nuclear fusion reactor 100, via the tandem mirror configuration, according to an embodiment. While described with respect to the reactor 100, the operations of the method 400 are equally applicable to any nuclear fusion reactor as described herein (e.g., the reactors 200, 300 described herein). All such implementations are envisioned and should be considered to be within the scope of the present application.

The method 400 includes generating the first axial magnetic field within the first confinement element 110a, the second axial magnetic field within the second confinement element 110b, and the third axial magnetic field within the third confinement element 110c, as previously described, at 402. At 404, a first fuel is disposed (e.g., inserted or injected) within the first confinement element 110a via the fuel source 130 to generate the first plasma population 120a, the first plasma population 120a at least partially confined in the radial direction within the first confinement element 110a via the first axial magnetic field, as previously described.

At 406, a second fuel is disposed within the second confinement element 110b via the fuel source 130 to generate the second plasma population 120b, the second plasma population 120b at least partially confined within the second confinement element 110b via the second axial magnetic field. At 408, a third fuel is disposed within the third confinement element 110c via the fuel source 130 to generate the third plasma population 120c, the third plasma population 120c at least partially confined within the third confinement element 110c via the third magnetic field.

At 410, the second plasma population 120b and the third plasma population 120c are heated via the heat source 140 to generate electrostatic barriers proximate the first axial end and the second axial end of the first confinement element 110a. The electrostatic barriers form the tandem mirror therebetween at least partially in the axial direction perpendicular to the radial direction. At 412, the first plasma population 120a is heated to the fusion temperature so as to cause fusion in the fuel forming the first plasma population, with the first plasma population 120a at least partially confined in the axial direction via the tandem mirror and in the at least partially in the radial direction by the first confinement element 110a. In some embodiments, the operations of the method 400 may be performed sequentially in the order described above. In some embodiments, the operations of the method 400 may be performed in other sequential orders, or some operations may be performed simultaneously, performed continuously, and/or performed for an extended period of time. In some embodiments, the first fuel, the second fuel, and the third fuel may be deuterium, tritium, or a combination thereof; however, in some embodiments, the first fuel may be a combination of deuterium and tritium, while the second fuel and the third fuel may be substantially tritium. However, as described herein, in some embodiments the second fuel and third fuel may be substantially deuterium. All such variations are envisioned herein and should be considered as part of the present disclosure.

As used herein, the terms “about” and “approximately” generally mean plus or minus 10% of the stated value. For example, about 0.5 would include 0.45 and 0.55, about 10 would include 9 to 11, about 1000 would include 900 to 1100.

As utilized herein, the terms “substantially’ and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “substantially” when used in connection with a numeric parameter is intended to convey that the numeric parameter may vary by about plus or minus about 5%. For example, the term “substantially uniform pressure” implies that the pressure applied may vary ±5% across the entire surface or volume being considered.

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the term “set” and “plurality” can refer to multiple features or a singular feature with multiple parts. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

When referring to elements or isotopes herein, it should be appreciated that the elements or isotopes may be in their base particle form or they may be ions thereof, unless specified otherwise. For example, the term “deuterium” as used herein may include, or refer to, particles of deuterium (e.g., D) and/or ions of deuterium (e.g., D+). Likewise, the term “tritium” as used herein may include, or refer to, particles of tritium (e.g., T) and/or ions of tritium (e.g., T+).

Additionally, an isotope may be referred to herein in terms of the chemical element and mass number (i.e., sum of protons and neutrons), and may be represented by any suitable forms common in the art, such as E-A and/or ^{A}E, where E is the chemical symbol of the element (and/or chemical name of the element) and A is the mass number (i.e., sum of protons and neutrons) of the isotope. For example, Tritium is an isotope of Hydrogen (H) having one proton, two neutrons, and, thus, a mass number of three. Hence, Tritium may be interchangeably referred to herein as “H-3,” “Hydrogen-3,” and/or “3H.” Isotopes may also include a reference to its atomic number Z (i.e., number of protons) in the symbol of the isotope (e.g., _{Z}^{A}E), but the atomic number may be omitted for simplicity. All such variations may be used interchangeably herein.

As used herein, the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples).

As used herein, the terms “including,” “comprising,” or “having,” “containing,” “involving” and variations thereof, are meant to encompass the items listed thereafter as well as, optionally, additional items. In the description the same numerical references refer to similar elements.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, the term “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The terms “coupled,” and the like as used herein mean the joining of two members directly or indirectly to one another. Such joining may be stationary (e.g., permanent) or moveable (e.g., removable, or releasable). Such joining may be achieved with the two members or the two members and any additional intermediate members being integrally formed as a single unitary body with one another or with the two members or the two members and any additional intermediate members being attached to one another.

All definitions, as defined and used herein, should be understood to control over dictionary definitions, definitions in documents incorporated by reference, and/or ordinary meanings of the defined terms.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions, and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A nuclear fusion reactor, comprising:
a first confinement element having axial ends, the first confinement element at least partially defining an inner region configured to have a first plasma population disposed therein, the first confinement element configured to produce an axial magnetic field between the axial ends and generate a magnetic mirror effect at each axial end, the axial magnetic field configured to at least partially confine the first plasma population in the inner region along a radial direction, and the magnetic mirror effect configured to at least partially confine the first plasma population in the inner region along an axial direction perpendicular to the radial direction;
a second confinement element disposed outside the first confinement element proximate a first axial end of the first confinement element, the second confinement element configured to have a second plasma population disposed therein; and
a third confinement element disposed outside the first confinement element proximate a second axial end of the first confinement element, the third confinement element configured to have a third plasma population disposed therein,
the second plasma population and the third plasma population configured to generate electrostatic barriers at each corresponding axial end, the electrostatic barriers configured to form a tandem mirror that further confines the first plasma population in the inner region along the axial direction.

2. The nuclear fusion reactor of claim 1, wherein the second plasma population and the third plasma population include a nuclear material having a mass over charge-squared ratio (μ/Z²) in a range of about 1.0 to about 3.5.

3. The nuclear fusion reactor of claim 1, wherein the second plasma population and the third plasma population include a nuclear material having a mass over charge-squared ratio (μ/Z²) of at least about 3.0.

4. The nuclear fusion reactor of claim 3, wherein the nuclear material includes at least one of tritium gas or tritium ions.

5. The nuclear fusion reactor of claim 1, further comprising:
expanders disposed proximate to and axially outwards of the corresponding second confinement element and third confinement element, the expanders configured to allow nuclear material escaping from the second and third confinement elements to expand.

6. The nuclear fusion reactor of claim 1, further comprising:
a heat source configured to heat the first plasma population, the second plasma population, and the third plasma population to generate a first electrostatic potential within the first plasma population, a second electrostatic potential within the second plasma population, and a third electrostatic potential within the third plasma population.

7. The nuclear fusion reactor of claim 6, wherein the heat source includes at least one of:
a neutral beam source configured to heat the second and third plasma populations via Neutral Beam Injection (NBI), or
an electron cyclotron heater configured to heat the second and third plasma populations via electron cyclotron waves.

8. The nuclear fusion reactor of claim 6, wherein each of the first plasma population, the second plasma population, and the third plasma population include a corresponding average electrostatic potential and a corresponding peak electrostatic potential.

9. The nuclear fusion reactor of claim 8, wherein the second electrostatic potential and the third electrostatic potential form the electrostatic barriers proximate to corresponding axial ends of the first confinement element.

10. The nuclear fusion reactor of claim 8, wherein the average electrostatic potential of each of the second plasma population and the third plasma populations is greater than the average electrostatic potential of the first plasma population.

11. The nuclear fusion reactor of claim 8, wherein the average electrostatic potential of each of the second plasma population and the third plasma population is less than the average electrostatic potential of the first plasma population.

12. The nuclear fusion reactor of claim 8, wherein the average electrostatic potential of each of the second plasma population and the third plasma population is about equal to the average electrostatic potential of the first plasma population.

13. The nuclear fusion reactor of claim 8, wherein the peak electrostatic potential of each of the second plasma population and the third plasma population is greater than the peak electrostatic potential of the first plasma population.

14. The nuclear fusion reactor of claim 8, wherein the peak electrostatic potential of each of the second plasma population and third plasma population is less than the peak electrostatic potential of the first plasma population.

15. The nuclear fusion reactor of claim 8, wherein the peak electrostatic potential of each of the second plasma population and the third plasma population is about equal to the peak electrostatic potential of the first plasma population.

16. The nuclear fusion reactor of claim 1, wherein each of the first, second, and third plasma populations include a corresponding nuclear material population therein such that each of the first, second, and third plasma populations has a corresponding average mass over charge-squared ratio (μ/Z²).

17. The nuclear fusion reactor of claim 16, wherein the average mass over charge-squared ratios (μ/Z²) of the second plasma population and the third plasma population are greater than the average mass over charge-squared ratio (μ/Z²) of the first plasma population.

18. The nuclear fusion reactor of claim 16, wherein the average mass over charge-squared ratios (μ/Z²) ratios of the second plasma population and the third plasma population are lesser than the average mass over charge-squared ratio (μ/Z²) of the first plasma population.

19. The nuclear fusion reactor of claim 1, wherein the second and third plasma populations are formed substantially of a combination of electrons and at least one of deuterium ions or particles.

20. A nuclear fusion reactor, comprising:
a confinement element having a first end and a second end opposite the first end, the confinement element at least partially defining an inner region configured to have a first plasma population disposed therein, the confinement element configured to produce an axial magnetic field between the first end and the second end, the axial magnetic field configured to confine the first plasma population within the inner region in a radial direction and generate a magnetic mirror effect at the first and second ends of the confinement element to at least partially confine the first plasma population in the inner region in an axial direction;
a first end plug disposed proximate the first end of the confinement element; and
a second end plug disposed proximate the second end of the confinement element;
the first end plug including a second plasma population, the second plasma population configured to form a first electrostatic barrier between the first end plug and the inner region and proximate the first end of the confinement element,
the second end plug including a third plasma population, the third plasma population configured to form a second electrostatic barrier between the second end plug and the inner region and proximate the second end of the confinement element, and
the first electrostatic barrier and the second electrostatic barrier forming a tandem mirror configured to further confine the first plasma population in the inner region in the axial direction perpendicular to the radial direction.

21. The nuclear fusion reactor of claim 20, wherein the second and third plasma populations have an average mass over charge-squared ratio (μ/Z²) of at least about 3.0.

22. The nuclear fusion reactor of claim 21, wherein the second and third plasma populations include ions formed substantially of tritium.

23. The nuclear fusion reactor of claim 20, wherein the second and third plasma populations include ions formed substantially of deuterium.

24. The nuclear fusion reactor of claim 20, further comprising:
a fuel source fluidically coupled to the confinement element, the fuel source configured to communicate fuel to the first plasma population.

25. The nuclear fusion reactor of claim 24, wherein the fuel source includes a neutral beam injector configured to direct a beam of neutral particles of the fuel to the first plasma population, the neutral beam injector configured to direct the beam of neutral particles to the first plasma population to generate an ion energy in a range of about 1 keV to about 1 MeV in the first plasma population so as to generate a fusion reaction in the inner region of the confinement element.

26. The nuclear fusion reactor of claim 25, further comprising:
a heat source fluidically coupled to the first end plug and the second end plug, the heat source configured to generate electron cyclotron resonance of electrons within the first and second plasma populations to heat the first and second plasma and increase an average electrostatic potential of the first and second end plugs to further axially confine the first plasma population within the inner region of the confinement element.

27. A method of using a nuclear fusion reactor including a first confinement element defining a first inner volume configured to contain a first plasma, a second confinement element defining a second inner volume configured to contain a second plasma, the second confinement element proximate to a first axial end of the first confinement element, and a third confinement element defining a third inner volume configured to contain a third plasma, the third confinement element proximate a second axial end of the first confinement element opposite the first axial end, the method comprising:
causing the first, second, and third confinement elements to generate corresponding axial magnetic fields, each axial magnetic field at least partially extending along an axial direction of the reactor within each corresponding inner volume;
communicating, via a fuel source, a first fuel into the first inner volume to generate the first plasma having a first average electrostatic potential, a second fuel into the second inner volume to generate the second plasma having a second average electrostatic potential, and a third fuel into the third inner volume to generate the third plasma having a third average electrostatic potential, the second and third fuels different from the first fuel, each of the first, second, and third plasmas at least partially radially confined in the first, second, and third inner volumes, respectively, via corresponding axial magnetic fields; and
heating, via a heat source, the second and third plasmas such that the second and third average electrostatic potentials are greater than the first average electrostatic potential, the second and third average electrostatic potentials axially confining the first plasma in the inner volume.

28. The method of claim 27, further comprising:
energizing, via the heat source, ions in the first plasma to promote a fusion reaction in the first plasma, the ions including deuterium and tritium.

29. The method of claim 28, wherein the first fuel includes at least one of deuterium and tritium, and the second and third fuels are substantially free of deuterium.

30. The method of claim 27, wherein the first fuel includes at least one of deuterium and tritium, and the second and third fuels are substantially free of tritium.
